(19) United States
(12) Patent Application Publication
(10) Pub. No.: US 2010/0229241 A1
(43) Pub. Date: Sep. 9, 2010

(54) METHOD OF ACCESSING SERVICE, DEVICE AND SYSTEM THEREOF

(76) Inventors: Yijun LIU, Shenzhen (CN); Hongtao GAO, Shenzhen (CN)

Correspondence Address: Huawei/BHGL, P.O. Box 10395, Chicago, IL, 60610, US

(21) Appl. No.: 12/783,142

(22) Filed: May 19, 2010

Related U.S. Application Data
(63) Continuation of application No. PCT/CN2009/070531, filed on Feb. 25, 2009.

(30) Foreign Application Priority Data
Feb. 28, 2008 (CN) 200810026519.1

(51) Int. Cl. H04L 9/00; G06F 21/00

(52) U.S. Cl. 726/26

(57) ABSTRACT

A method of service access, a device, and a system are provided in an embodiment of the present disclosure. A service requestor identity generating method includes the request for generating the anonymous identity that is adapted to hide the real identity of the client. A method of generating the identity of the service requestor, an access method, a method of tracing the real identity of the service requestor, a device for managing the identity of the service requestor, a service requestor device, an identity management system, a service provider device, an access system, an identity tracing requesting device, and an identity tracing system are provided in an embodiment of the present disclosure. The methods provided in an embodiment of the present disclosure may be used to protect the privacy of the service requestor while obtaining the real identity of the service requestor when necessary. The methods are easy to implement.

### CROSS-REFERENCE TO RELATED APPLICATIONS

This application is a continuation of International Application No. PCT/CN2009/070531, filed on Feb. 25, 2009, which claims priority to Chinese Patent Application No. 200810026519.1, filed on Feb. 28, 2008, both of which are hereby incorporated by reference in their entireties.

### FIELD OF THE DISCLOSURE

The present disclosure relates to the telecommunication field, and in particular, to a method of service access, device and system.

### BACKGROUND

Internet has become an important channel for communication, such as E-commerce, and plays a key role in people's daily lives. Many traditional communication modes have transformed to the modes using Internet communication. In addition to protecting against disclosure of the information in each communication session on the network, that is, enabling communication data security, the privacy of a network user must be protected. For example, in the services on a network, such as anonymous vote and anonymous auction, the real names of the service access parties may not be disclosed.

The existing technologies implement a method for enabling service access. The core idea is to use the public real identity of the service requestor as its public key and obtain the private key by calculating the public key of the service requestor and the main key of the Key Generating Center (KGC). The method is as follows:

The service requestor sends a real identity to the KGC to prove its true identity. The KGC generates a private key for access after the service requestor passes the identity verification. In addition, the KGC generates a private key for the service provider. When accessing the service provided by the service provider, the service requestor needs to complete negotiation between the two parties on the session keys during the access.

The service requestor needs to use its real identity to access the service provided by the service provider. Therefore, the service requestor may not access the service of the service provider anonymously. That is, the service requestor must provide its real identity to obtain the service of the service provider. In this case, the privacy of the service requestor may not be protected.

### SUMMARY

A method for generating the identity of the service requestor is provided in an embodiment of the present disclosure to address the preceding technical issue. The method includes:

obtaining the anonymous identity generating request from the anonymous service requestor; and

generating part or whole of the anonymous identity related to the real identity according to the anonymous identity generating request.

Accordingly, a device for managing the identity of the service requestor is provided in an embodiment of the present disclosure. The device includes:

a generating request obtaining unit, adapted to obtain the anonymous identity generating request from the anonymous service requestor; and

an anonymity generating unit, adapted to generate part or whole of the anonymous identity that is related to the real identity according to the anonymous identity generating request.

Accordingly, a device for managing the service requestor is provided in an embodiment of the present disclosure. The device includes:

a request sending unit, adapted to send the real identity of the anonymous service requestor and the request for generating the anonymous identity that is related to the real identity; and

a response receiving unit, adapted to receive the response to the request for generating the anonymous identity.

Accordingly, an identity generating system is provided in an embodiment of the present disclosure. The system includes a service requestor device and a service requestor identity management device. The service requestor device includes:

a request sending unit, adapted to send the real identity of the anonymous service requestor and the request for generating the anonymous identity that is related to the real identity; and

a response receiving unit, adapted to receive the response to the request for generating the anonymous identity.

and the device for managing an identity of a service requestor includes:

a generating request obtaining unit, adapted to obtain an anonymous identity generating request from the anonymous service requestor; and

an anonymity generating unit, adapted to generate part or whole of an anonymous identity that is related to a real identity according to the anonymous identity generating request.

A service requestor identity management device is provided in an embodiment of the present disclosure. The service requestor identity management device includes:

a storage unit, adapted to store corresponding relationship between a real identity of the service requestor accessing a service anonymously and an anonymous identity adapted to hide the real identity of the service requestor;

a tracing request obtaining unit, adapted to obtain the request for tracing the real identity of the service requestor; and

an inquiry unit, adapted to query the corresponding relationship according to the request for tracing the real identity of the service requestor and obtain the real identity.

The access method in the embodiment of the present disclosure involves:

generating the anonymous identity that is related to the real identity of the anonymous service requestor according to the anonymous identity generating request;

using the anonymous identity and the parameters signed by using the private key of the service requestor that is related to the anonymous identity and that is adapted to prove the legal anonymous identity of the service requestor to access the service, and redirect the service requestor to the requested service when the verification on the parameters for the anonymous identity of the service requestor is passed; and

querying the corresponding relationship between the real identity of the service requestor and the anonymous identity that is adapted to hide the real identity of the service requestor based on the request for tracing the real identity of the anonymous service requestor to obtain the real identity and respond to the tracing request, thus meeting the requirements for the privacy of the service requestor and obtaining the real identity when necessary.

### BRIEF DESCRIPTION OF THE DRAWINGS

FIG. 1 shows a main flowchart of a method of generating the identity of the service requestor in an embodiment of the present disclosure;

FIG. 2 shows a main flowchart of a method of generating the identity of the service requestor in an embodiment of the present disclosure;

FIG. 3 shows a main flowchart of an access method in an embodiment of the present disclosure;

FIG. 4 shows a main flowchart of a method of tracing the real identity of the service requestor in an embodiment of the present disclosure;

FIG. 5 shows a flowchart of an IBC-based traceable anonymous access method in an embodiment of the present disclosure;

FIG. 6 shows a flowchart of an IBC-based traceable anonymous access method in an embodiment of the present disclosure;

FIG. 7 shows a flowchart of a method of tracing the real identity of the service requestor in an embodiment of the present disclosure;

FIG. 8 shows a flowchart of an IBC-based traceable anonymous access method in an embodiment of the present disclosure;

FIG. 9 shows a main structure of an identity generating system in an embodiment of the present disclosure;

FIG. 10 shows a main structure of an identity generating system in an embodiment of the present disclosure;

FIG. 11 shows a main structure of an access system in an embodiment of the present disclosure;

FIG. 12 shows a main structure of an identity tracing system in an embodiment of the present disclosure;

FIG. 13 shows an example of an IBC-based traceable anonymous access method in an embodiment of the present disclosure;

FIG. 14 shows an example of an identity tracing system in an embodiment of the present disclosure; and

FIG. 15 shows an example of an IBC-based traceable anonymous access method in an embodiment of the present disclosure.

### DETAILED DESCRIPTION

The embodiments of the present disclosure provide a method of generating the identity of the service requestor, an access method, a method of tracing the real identity of the service requestor, a device for managing the identity of the service requestor, a service requestor device, an identity management system, a service provider device, an access system, an identity tracing requesting device, and an identity tracing system are provided in an embodiment of the present disclosure to generate the anonymous identity for the service requestor, access the service anonymously, and trace the real identity of the service requestor after anonymous access, thus protecting the privacy of the service requestor and obtaining the real identity when necessary to prove the initiated service access process.

The functional entities described in an embodiment of the present disclosure include but is not limited to:

a Key Generating Center (KGC), an entity with extended logical functions, the device for managing the identity of the service requestor and the authority administrator for the service requestor, adapted to: generate the private key for the service requestor in Identity-Based Cryptography (IBC) applications; manage the real identity of the managed service requestor and the properties of the subscribed services of the service requestor; and move the management functions to another independent functional entity, which is a device for managing the identity of the service requestor independent of the KGC, to form another entity of the present disclosure, such as the Identity Provider (IDP);

a client, a service requestor device or a service access initiator, which is managed by the KGC; and

an enabler, a service provider device or a service access receiver, which may belong to the same KGC with the client or a different KGC from the client.

The present disclosure is described as follows:

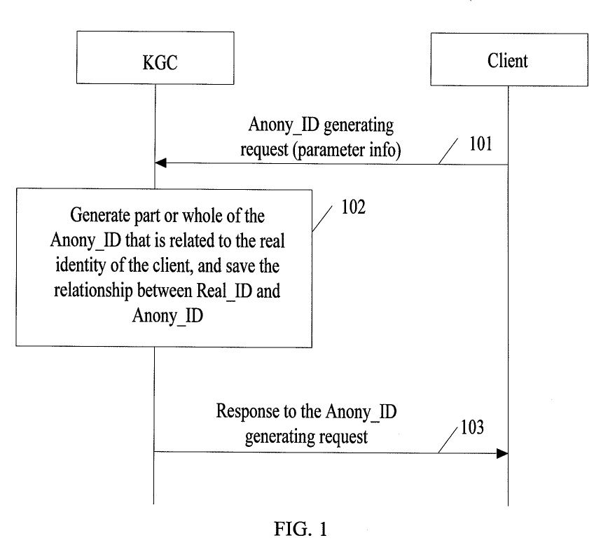

FIG. 1 is a main flowchart of a method of generating the identity of the service requestor in an embodiment of the present disclosure. The flowchart is based on the security channel established after mutual verification between the KGC and the client. The flowchart includes:

Step 101: The client selectively sends an Anony_ID generating request, that is, a request for generating an anonymous identity, to the KGC. This Anony_ID generating request may include one or any combination of the following parameters: real identity of the client (Real_ID), access attributes of the client (Access_Attribute), first random factor (RAND_{—}1), and part of the Anony_ID provided by the client (Anony_IDpostfix). Among these parameters, the Access_Attribute parameter may contain the information about the enabler to be accessed, that is, Enabler_ID, such as the Uniform Resource Locator (URL) of the enabler (Enabler_URL). The Access_Attribute parameter may contain the information about the access level of the service. The Anony_IDpostfix parameter may be obtained by calculating the random key t (a parameter similar to the main key s of the KGC) selected by the client and the P parameter of the KGC public parameters (the meanings of the public parameters are defined on the basis of the cryptography-based discrete logarithm. These parameters are clear. The P parameter herein is the generating unit P selected by group G1 to generate the formula PPUB=sP). That is, Anony_IDpostfix=tP.

Step 102: The KGC generates part or all of the Anony_ID that is related to the real identity of the client and saves the corresponding relationship between the real identity (Real_ID) and the Anony_ID for the use of tracing the real identity. The KGC is adapted to:

generate all of the Anony_ID of the client by using a Hash algorithm with the Real_ID and RAND_{—}1 as the generating factors, that is, Anony_ID=H(Real_ID+RAND_{—}1), and determines the corresponding relationship between Real_ID and Anony_ID when the Anony_ID generating request contains the Real_ID and RAND_{—}1 of the client; or

generate all of the Anony_ID of the client by using the Hash algorithm with the Real_ID, RAND_{—}1, and Access_Attribute as the generating factors and by combining the Access_Attribute after the client is verified as having the access attributes indicated by the Access_Attribute (for example, the client and the enabler are associated, that is, the enabler may provide services to the client), that is, Anony_ID=Access_Attribute+H(Real_ID+RAND_{—}1); and determine the corresponding relationship between Real_ID and Anony_ID when the Anony_ID generating request contains the Real_ID, RAND_{—}1, and Access_Attribute of the client; or

generate the prefix of the Anony_ID by using the preceding method after the Anony_IDpostfix is verified as meeting the requirement for the anonymous identity, that is, Anony_IDprefix=H(Real_ID+RAND_{—}1); forms the Anony_ID by combining Anony_IDpostfix and Anony_IDprefix, that is, Anony_ID=Anony_IDprefix+Anony_IDpostfix; sign the Anony_IDpostfix, that is, Sign^{PrvKey}^{_{KGC}}(Anony_ID postfix); and determine the corresponding relationship between Real_ID and Anony_ID when the Anony_ID generating request contains the Anony_IDpostfix provided by the client; or

generate part or all of the Anony_ID that is related to the real identity of the client, or uses an identity that is not generated by the Real_ID as part or all of the Anony_ID. For example, the KGC may provide an identity A (such as a certain random number generated by the KGC and a combination of a certain random number and a date). The identity A is not generated by using the Real_ID as the generating factor. In this case, the KGC only needs to determine the corresponding relationship between the Real_ID and the identity A of the Anony_ID.

Until now, the KGC generates part or all of the Anony_ID that is related to the real identity of the client. To improve the present disclosure, step 103 may be included.

Step 103: The KGC responds to the Anony_ID generating request of the client, and sends part or all of the Anony_ID that is related to the real identity to the client. When the KGC signs the Anony_IDpostfix, the KGC sends the Sign^{PrvKey}^{_{KGC}}(Anony_IDpostfix) with the response to the client to indicate that the Anony_IDpostfix meets the requirement for the anonymous identity. In addition, when the KGC fails in the preceding step (for example, the client is not associated with the enabler in step 102), the KGC sends an error or end message to the client.

The method for generating the identity of the service requestor as shown in FIG. 1 helps generate an anonymous identity that is related to the real identity according to the request for generating an anonymous identity for the service requestor, thus meeting the requirement for privacy of the service requestor and improving user satisfaction.

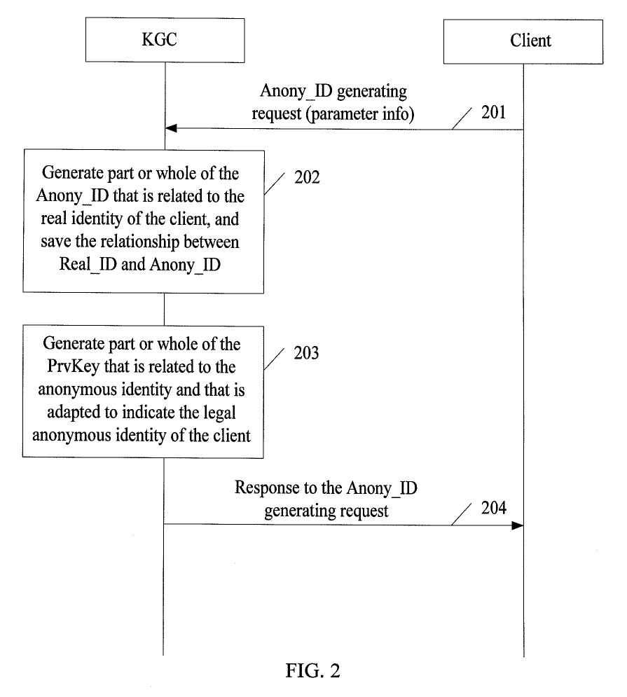

FIG. 2 shows a main flowchart of a method of generating the identity for the service requestor. This flowchart describes the method for generating a private key for the service requestor in the prerequisite that the anonymous identity of the service requestor is generated and that a security channel is established through mutual verification between KGC and client. The flowchart includes:

Step 201: The client selectively sends an Anony_ID generating request to the KGC. This Anony_ID generating request may contain one or any combination of the parameters described in step 101.

Step 202: The KGC generates part or all of the Anony_ID that is related to the real identity of the client based on the Anony_ID generating request, or saves the corresponding relationship between the real identity (represented by the Real_ID) and the Anony_ID. For details, see step 102.

Step 203: After generating part or all of the Anony_ID that is related to the real identity of the client, the KGC generates part or whole of the private key (PrvKey) that is related to the Anony_ID and that is adapted to represent the legal anonymous identity of the client. Meanwhile, the Anony_ID is used as the public key of the client. The KGC is adapted to:

generate all of the Anony_ID of the client by using the Hash algorithm with Real_ID and RAND_{—}1 as the generating factors, that is, Anony_ID=H(Real_ID+RAND_{—}1); determines the corresponding relationship between Real_ID and Anony_ID; perform Hash algorithm for the Anony_ID to obtain the Hash value; generates all of PrvKey of the client by using the Hash value and the key s of the KGC as the generating factors, that is, PrvKey=sH1(Anony_ID)=sH1(H(Real_ID+RAND_{—}1)); and use the Anony_ID as the public key of the client when the Anony_ID generating request includes Real_ID and RAND_{—}1 of the client; or

generate all of the Anony_ID of the client by using the Hash algorithm with the Real_ID, RAND_{—}1, and Access_Attribute as the generating factors and by combining the Access_Attribute after the client is verified as having the access attributes indicated by the Access_Attribute (for example, the client and the enabler are associated, that is, the enabler may provide services to the client), that is, Anony_ID=Access_Attribute+H(Real_ID+RAND_{—}1); determine the corresponding relationship between Real_ID and Anony_ID; performs Hash calculation for the Anony_ID to obtain the Hash value of the Anony_ID; generate all of PrvKey of the client by using the Hash value and the main key s of the KGC as the generating factors, that is, PrvKey=sH1(Anony_ID)=sH1(H(Real_ID+RAND_{—}1)); and use the Anony_ID as the public key of the client when the Anony_ID generating request contains the Real_ID, RAND_{—}1, and Access_Attribute of the client; or

generate the prefix of the Anony_ID by using the preceding method after the Anony_IDpostfix is verified as meeting the requirement for the anonymous identity (for example, the requirement for digit restriction policy), that is, Anony_IDprefix=H(Real_ID+RAND_{—}1); obtain the Anony_ID by combining Anony_IDpostfix and Anony_IDprefix, that is, Anony_ID=Anony_IDprefix+Anony_IDpostfix; sign the Anony_IDpostfix, that is, Sign^{PrvKey}^{_{KGC}}(Anony_IDpostfix); determine the corresponding relationship between Real_ID and Anony_ID; perform Hash calculation for the Anony_IDprefix; generate part of PrvKey of the client (PrvKeypart) using the Hash value and the main key s of the KGC as the generating factors, that is, PrvKeypart=sH1(Anony_IDprefix)=sH1(H(Real_ID+RAND_{—}1)); and use the Anony_ID as the public key of the client, that is, PrvKey=PrvKeypart+t H1(Anony_IDprefix), in which, t is a random key selected by the client when the Anony_ID generating request contains the Anony_IDpostfix provided by the client; or

generate part or all of the Anony_ID that is related to the real identity of the client. The identity not generated by the Real_ID may be used as part or all of the Anony_ID. For example, the KGC may provide an identity A (such as a certain random number generated by the KGC and a combination of a certain random number and a date). The identity A is not generated by using the Real_ID as the generating factor. In this case, the corresponding relationship between the Real_ID and the identity A of the Anony_ID needs to be specified. Then, the Hash value obtained through calculation of the Anony_ID (that is, identity A) and the main key s of the KGC are used as the generating factors to generate all of PrvKey of the client (PrvKey). That is, PrvKey=sH₁(Anony_ID)=sH₁(A). Meanwhile, the Anony_ID is used as the public key of the client.

Until now, the KGC generates part or all of the Anony_ID that is related to the real identity of the client and part or all of the PrvKey that is related to the Anony_ID and that is adapted to represent the legal anonymous identity of the client. To improve the present disclosure, step 204 may be included.

Step 204: The KGC responds to the Anony_ID generating request of the client, and sends part or all of the Anony_ID that is related to the real identity and part or all of PrvKey to the client. Or the KGC responds to the private key generating request of the client and sends part or all of PrvKey (but not Anony_ID) to the client. The client generates the Anony_ID by using the method of generating the Anony_ID by the KGC. When the KGC signs the Anony_IDpostfix, the KGC sends the Sign^{PrvKey}^{_{KGC}}(Anony_IDpostfix) with the response to client to indicate that the Anony_IDpostfix meets the requirement for the anonymous identity. In addition, when the KGC fails in the preceding step (for example, the client is not associated with the enabler in step 302), the KGC sends an error or end message to the client.

The method for generating the identity and private key for the service requestor as shown in FIG. 2 helps generate the anonymous identity that is related to the real identity according to the request for generating an anonymous identity for the real identity of the anonymous service requestor, and generate part or whole of the private key that is related to the anonymous identity and that is adapted to prove the legal anonymous identity of the service requestor, thus providing the anonymous identity and private key for anonymous access of the service requestor, meeting the requirement for privacy, and improving user satisfaction.

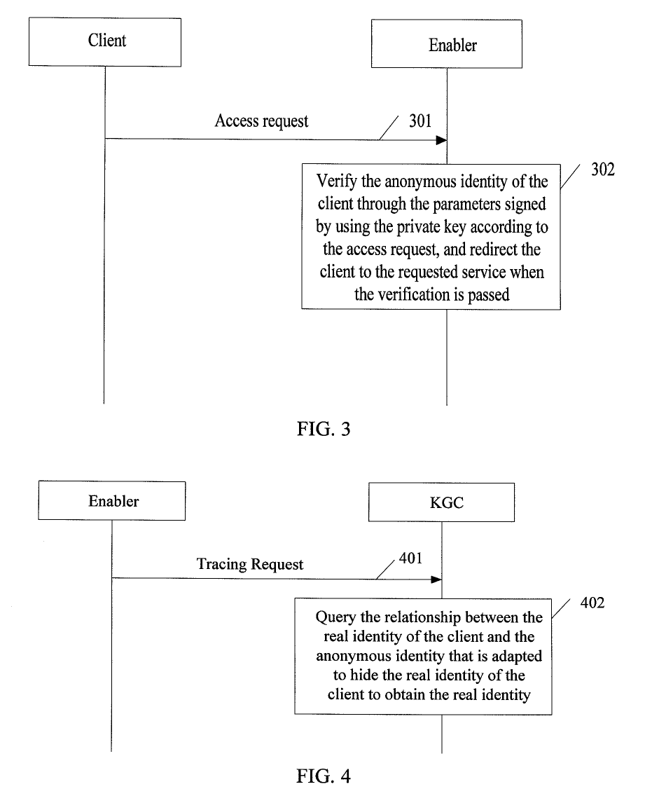

FIG. 3 shows a main flowchart of a method provided in an embodiment of the present disclosure. The flowchart implements service access based on the anonymous identity and private key for the service requestor generated in FIG. 2. The flowchart includes:

Step 301: The client sends a service access request to the enabler. The access request carries the Anony_ID of the client and the p* parameter (Sign_{PrvKey}(p*)) that is related to the Anony_ID and that is signed by PryKey of the client that is adapted to prove the legal anonymous identity of the client. The access request may contain a second random factor (for example, RAND_{—}2, or the overall calculation result of RAND_{—}2 and the Hash value of Anony_ID generated by the client, that is, RAND_{—}2H₁(Anony_ID)). When the client and the enabler belong to different KGCs (when the client and enabler belong to a same KGC, the information about the homing authority administrator claimed by the client may be excluded), the access request may contain the information about the homing authority administrator claimed by the client, that is, the information about the KGC to which the client belongs, for example, KGC_URL. When the Anony_ID includes the Anony_ID_{prefix} generated by the KGC and Anony_M_{postfix} provided by the client, the Anony_ID may contain the access attribute information of the client (Access_Attribute). When the Anony_ID includes the Anony_ID_{postfix}, the access request may contain the information signed by the KGC for the Anony_ID_{postfix}(Sign_{PrvKey}_{_{KGC}}(Anony_ID_{postfix})). In addition to the second random factor, the p* parameter may contain one or any combination of Anony_ID, KGC_URL, and phase effective factor (such as the date data and counter setting), thus preventing the data packet or field of the p* parameter from being repeated.

Step 302: The enabler obtains the service access request from the client, and verifies the p* parameter signed by PrvKey for the anonymous identity of the client based on the access request. When the verification is passed, the enabler redirects the client to the requested service. After the related parameters are extracted from the access request:

when the access request contains the KGC_URL, and the Anony_ID contains the Access_Attribute of the client, the following procedure may be included in addition to the verification of the p* parameter signed by PrvKey for the anonymous identity of the client: The KGC is verified according to the KGC_URL and Access_Attribute and for the authorization qualification of the Access_Attribute. If the verification is passed, the verification of the p* parameter signed by PrvKey for the anonymous identity of the client is triggered; or

when the Anony_ID contains part of the Anony_ID provided by the client and the homing KGC claimed by the client signs part of the Anony_ID provided by the client, part of the Anony_ID provided by the client is verified during the verification of the p* parameter signed by PrvKey for the anonymous identity of the client.

The procedure for verifying the p* parameter signed by PrvKey for the anonymous identity of the client is to obtain the public parameter of the KGC and judge whether the PrvKey signing is correct based on the public parameter. If the PrvKey signing is correct, the verification is passed.

Until now, the client and the enabler complete verifying the anonymous identity of the client.

When the p* parameter contains the second random factor, the third random factor is set and signed for determining the session key used by the access based on the second random factor after the verification of the p* signed by PryKey for the anonymous identity of the client is passed. When the verification of the signing of the third random factor by the client is passed, the third random factor is adapted to determine the session key used by the access. When the p* parameter contains the second random factor RAND_{—}2, the third random factor that is adapted to determine the session key used by the access is RAND_{—}2 after the verification of the p* signed by PrvKey for the anonymous identity of the client is passed. The RAND_{—}2 is signed by using the private key PrvKey_{Enabler} of the enabler to obtain the signing value Sign_{PrvKey}_{_{Enabler}}(RAND_{—}2). After receiving the Sign_{PrvKey}_{_{Enable}}(RAND_{—}2) sent by the enabler, the session key used for the access is RAND_{—}2 when the verification of the Sign_{PrvKey}_{_{Enabler}}(RAND_{—}2) by the client is passed (the obtained signed RAND_{—}2 is the second random factor RAND_{—}2 sent in step 301). At this time, an access security channel with RAND_{—}2 as the session key is considered as being established. The client and the enabler may exchange access information. When the second random factor contained in the p* parameter is an overall calculation result of the RAND_{—}2 and the Hash value of Anony_ID generated by the client, that is, RAND_{—}2H₁(Anony_ID), the third random factor that is adapted to determine the session key used by the access is the overall calculation result of the RAND_{—}3 and the Hash value of Enabler_ID provided by the enabler, that is, RAND_{—}3H₁(Enabler_ID), after the verification of the p* signed by PrvKey for the anonymous identity of the client is passed. The RAND_{—}3H₁(Enabler_ID) is signed by using the private key PrvKey_{Enabler} of the enabler to obtain the signing value Sign_{PrvKey}_{_{Enabler}}(RAND_{—}3H₁(Enabler_ID)). After receiving the Sign_{PrvKey}_{_{Enabler}}(RAND_{—}3H₁(Enabler_ID)) from the enabler, the client confirms that the session key used for the access is Key_{Client-Enabler}=ê(PrvKey, RAND_{—}3H₁(Enabler_ID)+RAND_{—}2H₁(Enabler_ID)) when the verification of the Sign_{PryKey}_{_{Enabler}}(RAND_{—}3H₁(Enabler_ID) by the client is passed (that is, the obtained signed RAND_{—}3H₁(Enabler_ID) is the comparison value RAND_{—}3H₁(Enabler_ID) carried in the access request). The enabler confirms that the session key used for the access is Key_{Enabler-Client}=ê(PrvKey_{Enabler}, RAND_{—}2H₁(Anony_ID)+RAND_{—}3H₁(Anony_ID)). At this time, an access security channel with Key_{Client-Enabler}=Key_{Enabler-Client} as the session key is established. Then the client and the enabler may exchange access information.

Until now, the client and the enabler complete negotiation for the session key for access.

The access method as shown in FIG. 3 helps access the service by using the anonymous identity and the parameter signed by the private key of the service requestor that is related to the anonymous identity and that is adapted to prove the legal anonymous identity of the service requestor and redirect the service requestor to the requested service when the verification of the parameter signed by the private key for the anonymous identity of the service requestor, thus enabling anonymous access of the service requestor, meeting the requirement for the privacy of the service requestor, and improving user satisfaction.

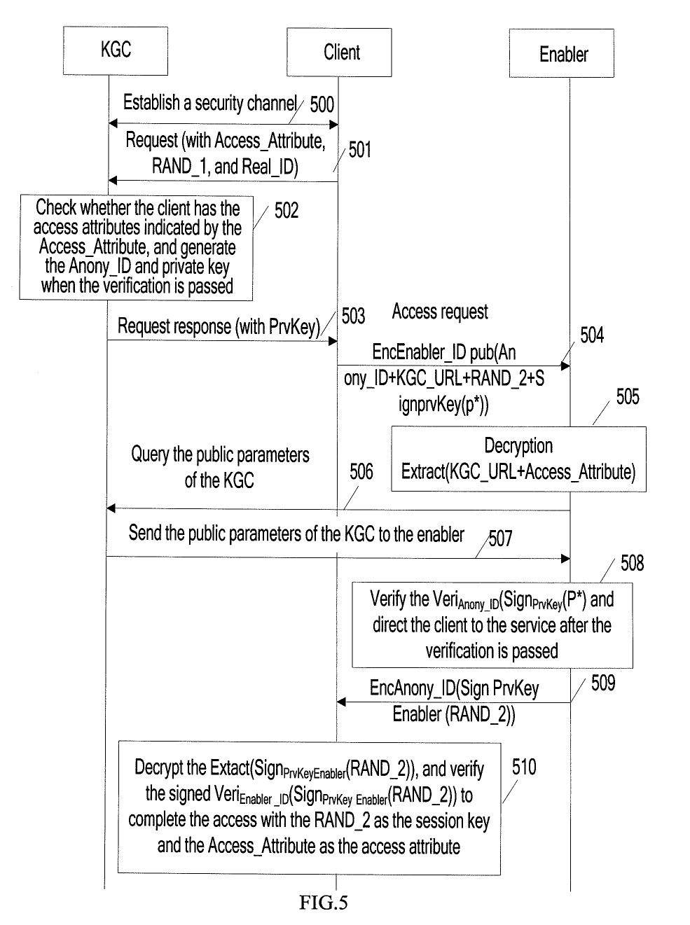

FIG. 4 shows a main flowchart of the method of tracing the real identity of the service access party in an embodiment of the present disclosure. The flowchart includes:

Step 401: The KGC obtains the request (with the Anony_ID provided by the client) for tracing the real identity of the client that accesses the service anonymously from the enabler. That is, the enabler applies an arbitration voucher (that may be carried in the tracing request) from the arbiter for tracing the real identity of the client to request the KGC for providing the real identity of the client before the KGC obtains the tracing request. The enabler may provide the access record (or transaction record) of the client.

Step 402: The KGC queries the corresponding relationship between the real identity of the client and the Anony_ID that is adapted to hide the real identity of the client according to the tracing request (that may carry the Anony_ID provided by the client and the arbitration voucher) sent by the enabler and obtains the real identity of the client. That is, the KGC proves the authenticity of the arbitration voucher from the arbiter. When the arbitration voucher is proven authentic, the KGC queries the real identity of the client.

The method for tracing the real identity of the service requestor as shown in FIG. 4 helps query the corresponding relationship between the real identity of the service requestor and the anonymous identity that is adapted to hide the real identity according to the request for tracing the real identity of the anonymous service requestor and obtain the real identity to respond to the tracing request, thus obtaining the real identity of the service requestor when necessary to prove the initiated service access process.

The preceding are the main flows of the methods provided in an embodiment of the present disclosure. The applications using the methods are described as follows:

FIG. 5 shows a flowchart of an IBC-based traceable anonymous access method in an embodiment of the present disclosure. The method includes:

Step 500: The KGC and the client establish a security channel after mutual verification. That is, the KGC and the client establish mutual trust, and a security channel based on this trust. This process may be implemented by using the existing technologies and may be contained in step 501.

Step 501: The client sends a request for obtaining the public key and private key used in anonymous access to the KGC. This request may also serve as the request for generating the anonymous identity for the client. The request contains the following parameters: Access_Attribute (access attribute information of the client that may contain the requested enabler information, that is, Enabler_ID, such as Enabler_URL), RAND_{—}1, and Real_ID.

Step 502: The KGC queries whether the client is verified by the enabler as having the access attributes (for example, the client is associated with the enabler, that is, the enabler may provide services to the client) indicated by the Access_Attribute parameter (such as Enabler_URL). If the verification is passed, the KGC generates the Hash value for the RAND_{—}1 and Real_ID carried in the request by using the Hash algorithm (for example, Message Digest 5 or Secure Hash Algorithm −1). That is, the real identity of the client is hidden. This Hash value H(Real_ID+RAND_{—}1) and the Access_Attribute construct the anonymous identity for the real identity of the client, Anony_ID=Access_Attribute+H(Real_ID+RAND_{—}1). Otherwise, the KGC returns an error or end message to the client. After the Anony_ID of the client is generated, the Anony_ID is used as the public key for the client that uses the IBC-based traceable anonymous access method. In addition, the public key Anony_ID is adapted to generate a private key PrvKey that is related to the Anony_ID and that is adapted to prove the legal anonymous identity of the client. That is, PrvKey=sH₁(Anony_ID)=sH₁(Access_Attribute+H(Real_ID+RAND_{—}1)). When the private key PrvKey is generated, it means that the KGC acknowledges the Access_Attribute of the client and completes binding the corresponding relationship to the private key PrvKey.

Step 503: T he KGC sends the PrvKey related to the Anony_ID through the security channel to the client in response to the request in step 501. When this step is complete, it means that the client obtains authorization from the KGC to anonymously access the service. The PrvKey indicates the acknowledgement of the anonymous access right. The value signed by using the PrvKey (encrypted by PrvKey) may be adapted only to decrypt the Anony_ID. In addition, the public key Anony_ID of the client may be generated by using the similar method of generating a public key by the KGC in step 502.

The KGC may use other methods to generate the PrvKey related to the Anony_ID. However, the real identity of the client must be uniquely mapped to the Anony_ID.

Step 504: The client sends a service access request to the enabler. The access request carries the parameters encrypted by using the public key Enabler_ID of the enabler, that is, Enc_{Enabler}_{_{—}}_{ID}(Anony_ID+KGC_URL+RAND_{—}2+Sign_{PrvKey}(p*)). The parameters include: Anony_ID (that is, Access_Attribute+H(Real_ID+RAND_{—}1)), KGC_URL of the homing KGC claimed by the client, RAND_{—}2, and signing value of the p* parameter by the PrvKey(Sign_{PrvKey}(p*)). The p* parameter may contain one or any combination of the Anony_ID, KGC_URL, and phase valid factor (such as the date data and counter setting) in addition to RAND_{—}2 to prevent the homing data packet or field of the p* parameter from being repeated. The Sign_{PrvKey}(p*) implies the information of transmitting the binding corresponding relationship of the client acknowledged by the Access_Attribute to the enabler, so that the enabler may verify the binding corresponding relationship.

Step 505: The enabler uses its own private key PrvKey_{Enabler} to decrypt the encrypted parameter set in the access request and extracts the parameter through resolution, that is, Extract(KGC_URL+Access_Attribute), to obtain the KGC_URL and Anony_ID (that contains the Access_Attribute) and check whether the KGC is trustworthy and whether the KGC is qualified to authorize the Access_Attribute. If the verification is passed, proceed with the subsequent processing. Other parameters, such as Sign_{PrvKey}(p*), may also be obtained through the decryption.

Step 506: The enabler queries the IBC public parameters of the homing KGC (indicated by the KGC_URL) of the client.

Step 507: The KGC sends the public parameters to the enabler.

If the client and the enabler belong to a same KGC, steps 506 and 507 may be skipped. If the client and the enabler belong to different KGCs, the enabler queries related information in the homing KGC by using different methods.

Step 508: After obtaining the IBC public parameter of the homing KGC of the client, the enabler judges (Veri_{Anony}_{_{—}}_{ID}(Sign_{PrvKey}(p*))) whether the PrvKey signing is correct based on the public parameter (such as Anony_ID), that is, whether the Sign_{PrvKey}(p*) is correct. If the Sign_{PrvKey}(p*) is correct, it indicates that the verification of the p* parameter signed by the PrvKey for the anonymous identity of the client is passed and that the Anony_ID is acknowledged by the KGC. In addition, the enabler obtains the RAND_{—}2, uses its own private key PrvKey_{Enabler} to sign the RAND_{—}2 to obtain the Sign_{PrvKey}_{_{Enabler}}(RAND_{—}2), and redirects the client to the requested service according to the Access_Attribute. The access request of the client is processed according to the attributes indicated by the Access_Attribute. The indicated attributes, such as service, are divided into high, medium, and low levels.

Step 509: The enabler performs IBC encryption on the Sign_{PrvKey}_{_{Enabler}}(RAND_{—}2) by using the public key Anony_ID of the client to obtain the Enc_{anony}_{_{—}}_{ID}(Sign_{PrvKey}_{_{Enabler}}(RAND_{—}2)) and send it to the client to indicate that the enabler correctly receives the RAND_{—}2 and that the enabler completes authentication for the binding corresponding relationship of the client acknowledged by the Access_Attribute in step 504.

Step 510: After receiving the Enc_{anony}_{_{—}}_{ID}(Sign_{PrvKey}_{_{Enabler}}(RAND_{—}2)), the client decrypts (that is, Extract(Sign_{PrvKey}_{_{Enabler}}(RAND_{—}2))) it by using the private key PrvKey, verifies (that is, Veri_{Enabler}_{_{—}}_{ID}(Sign_{PrvKey}_{_{Enabler}}(RAND_{—}2))) the signing of the RAND_{—}2 by using the public key Enabler_ID of the enabler, and checks whether the signing value is the RAND_{—}2 in step 504. If the signing value is the RAND_{—}2 in step 504, the client confirms that the session key used for the access is the RAND_{—}2. In this case, the access security channel with the RAND_{—}2 as the session key is considered as being established. Then the client and the enabler may exchange access information.

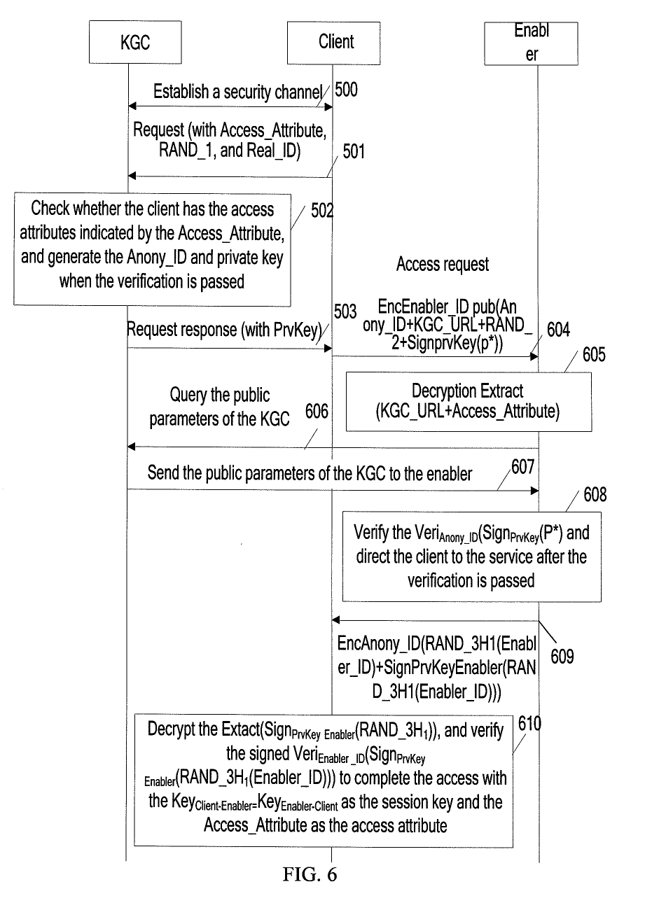

As an alternative scheme, the IBC-based traceable anonymous access method in FIG. 6 may be adapted to replace the procedure from step 504 to step 510.

Step 604: The client sends a service access request to the enabler. The access request carries the parameters encrypted by using the public key Enabler_ID of the enabler, that is, Enc_{Enabler}_{_{—}}_{ID}(Anony_ID+KGC_URL+RAND_{—}2H₁(Anony_ID)+Sign_{PrvKey}(p*)). The parameters include: Anony_ID (that is, Access_Attribute+H(Real_ID+RAND_{—}1)), KGC_URL of the homing KGC claimed by the client, and overall calculation result of the RAND_{—}2 and the Has value of the Anony_ID generated by the client (that is, RAND_{—}2H₁(Anony_ID)), and signing value of the p* parameter by the PrvKey(Sign_{PrvKey}(p*)). The p* parameter may contain one or any combination of the Anony_ID, KGC_URL, and phase valid factor (such as the date data and counter setting) in addition to RAND_{—}2H₁(Anony_ID) to prevent the homing data packet or field of the p* parameter from being repeated. The Sigh_{PrvKey}(p*) implies the information of transmitting the binding corresponding relationship of the client acknowledged by the Access_Attribute to the enabler, so that the enabler may verify the binding corresponding relationship.

Step 605: The enabler uses its own private key PrvKey_{Enabler} to decrypt the encrypted parameter set in the access request to obtain the KGC_URL and Anony_ID (that contains the Access_Attribute) and check whether the KGC is trustworthy and whether the KGC is qualified to authorize the Access_Attribute. If the verification is passed, proceed with the subsequent processing. Other parameters, such as Sign_{PrvKey}(p*), may also be obtained through the decryption.

Step 606: The enabler queries the IBC public parameters of the homing KGC (indicated by the KGC_URL) of the client.

Step 607: The KGC sends the public parameters to the enabler.

If the client and the enabler belong to a same KGC, steps 606 and 607 may be skipped. If the client and the enabler belong to different KGCs, the enabler queries related information in the homing KGC by using different methods.

Step 608: After obtaining the public parameter of the homing KGC of the client, the enabler judges whether the PrvKey signing is correct based on the public parameter, that is, whether the Sign_{PrvKey}(p*) is correct. If the Sign_{PrvKey}(p*) is correct, it indicates that the verification of the p* parameter signed by the PrvKey for the anonymous identity of the client is passed and that the Anony_ID is acknowledged by the KGC. In addition, the enabler extracts and obtains the RAND_{—}2H₁(Anony_ID), uses a method similar to that for generating the RAND_{—}2H₁(Anony_ID) by the client to generate the overall calculation result of the RAND_{—}3 and the Hash value of the Enabler_ID provided by the enabler (that is, RAND_{—}3H₁(Enabler_ID)), uses the private key PrvKey_{Enabler} of the enabler to sign the RAND_{—}3H₁(Enabler_ID) to obtain the Sign_{PrvKey}_{_{Enabler}}(RAND_{—}3H₁(Enabler_ID)), and redirects the client to the requested service according to the Access_Attribute. The access request of the client is processed according to the attributes indicated by the Access_Attribute. The indicated attributes, such as service, are divided into high, medium, and low levels.

Step 609: The enabler performs IBC encryption on the Sign_{PrvKey}_{_{Enabler}}(RAND_{—}3H₁(Enabler_ID)) by using the public key Anony_ID of the client to obtain the Enc_{anony}_{_{—}}_{ID}(RAND_{—}3H₁(Enabler_ID)+Sign_{PrvKey}_{_{Enabler}}(RAND_{—}3H₁(Enabler_ID))) and send it to the client to indicate that the enabler correctly receives the RAND_{—}2H₁(Anony_ID) and that the enabler completes authentication for the binding corresponding relationship of the client acknowledged by the Access_Attribute in step 604.

Step 610: After receiving the Enc_{anony}_{_{—}}_{ID}(RAND_{—}3H₁(Enabler_ID)+Sign_{PrvKey}_{Enabler}(RAND_{—}3H₁(Enabler_ID))), the client decrypts it by using the private key PrvKey, verifies (that is, Veri_{Enabler}_{_{—}}_{ID}(Sign_{PrvKey}_{_{Enabler}}(RAND_{—}3H₁(Enabler_ID)))) the signing of the RAND_{—}2 by using the public key Enabler_ID of the enabler, and checks whether the signing value is the RAND_{—}3H₁(Enabler_ID). If the signing value is the RAND_{—}3H₁(Enabler_ID), it is regarded that the client correctly receives the related parameters sent by the client before and that the anonymous identity of the client is legal. The client confirms that the session key used by the access is Key_{Client-Enabler}=ê(PrvKey, RAND_{—}3H₁(Enabler_ID)+RAND_{—}2H₁(Enabler_ID)). The enabler confirms that the session key used by the access is Key_{Enabler-Client}=ê(PrvKey_{Enabler}, RAND_{—}2H₁(Anony_ID)+RAND_{—}3H₁(Anony_ID)). In this case, the access security channel with the RAND_{—}2 as the session key is considered as being established. Then the client and the enabler may exchange access information.

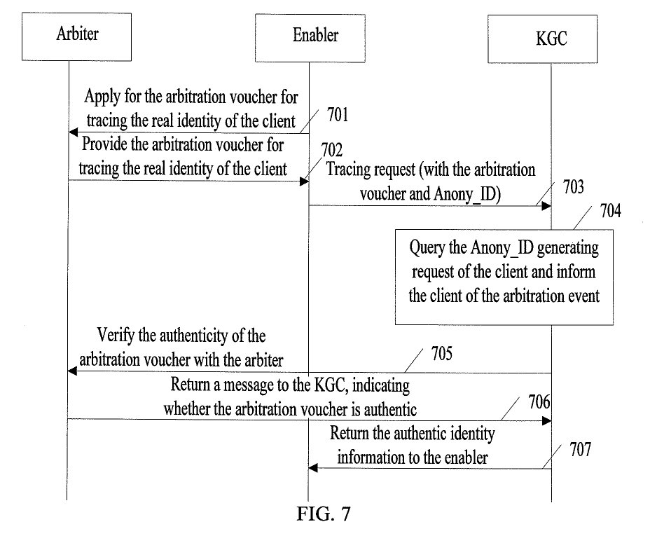

FIG. 7 shows a method of tracing the real identity of the service requestor in an embodiment of the present disclosure. The method includes:

Step 701: The enabler applies an arbitration voucher to the arbiter for tracing the real identity of the client and provides the access record or transaction record of the anonymous access of the client. The access record or transaction record contains the related record of signing the Anony_ID by the client during the access.

Step 702: The arbiter reviews the access record signed by the client with the Anony_ID from the enabler to determine whether to arbitrate the Anony_ID. When the arbiter decides to arbitrate the Anony_ID, the arbiter provides the arbitration voucher for tracing the real identity of the client.

Step 703: After obtaining the arbitration voucher, the enabler provides the KGC with the request for tracing the real identity of the client that contains the arbitration voucher and the Anony_ID to ask the KGC to provide the real identity of the client that is related to the Anony_ID.

Step 704: The KGC queries the record about the Anony_ID generating request of the client according to the tracing request of the enabler and informs the client of the arbitration event of the arbiter.

Step 705: The KGC verifies the authenticity of the arbitration voucher with the arbiter.

Step 706: The arbiter returns a message to the KGC, indicating whether the arbitration voucher is authentic.

Step 707: When the arbiter returns a message that indicates the authenticity of the arbitration voucher, the KGC queries the corresponding relationship between the real identity of the client and the Anony_ID that is adapted to hide the real identity of the client to obtain the real identity of the client and return the real identity to the enabler.

The tracing flow may be adapted to verify the real identity of the client when necessary. The arbitration process involves non-technical aspects that are not described herein.

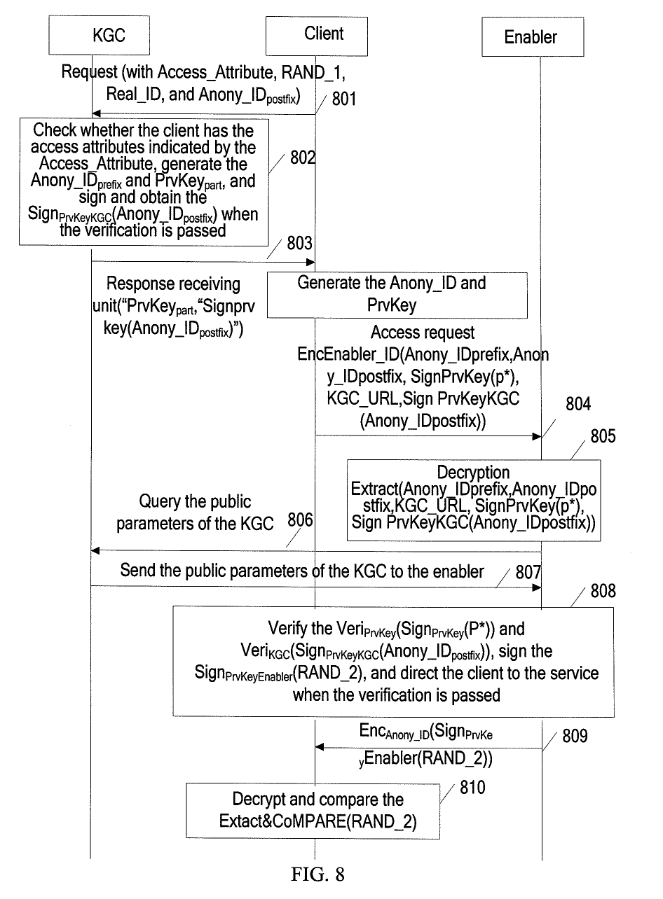

In addition, when the client needs to participate in generation of the anonymous identity and private key of the client, FIG. 8 shows a third case of an IBC-based traceable anonymous access method. The method includes:

Step 801: The client sends a request to the KGC for obtaining the public key and private key used for the anonymous access of the client. This request includes RAND_{—}1, Real_ID (real identity of the client), and part (suffix) of the Anony_ID provided by the client (that is, Anony_IDpostfix). The Anony_IDpostfix may be obtained through calculation of the random key t selected by the client and P in the KGC public parameter, that is, Anony_IDpostfix=tP. In step 801, the client may contain only the anonymous access request that carries tP. The request may contain information such as the Access_Attribute. The following flow takes the scenario when the Access_Attribute information is contained as an example. The following flow, however, is applicable to the scenarios when other information is contained.

Step 802: The KGC checks whether the Anony_ID_{postfix} meets the requirement for the digit restriction policy and whether the client has the access attributes indicated by the Access_Attribute (for example, the client is associated with the enabler, that is, the enabler may provide services to the client). If the two conditions are met, the KGC generates part (prefix) of the Anony_ID(Anony_ID_{prefix}=H(Real_ID+RAND_{—}1)). The Anony_ID_{prefix} combines with the Anony_ID_{postfix} to form the Anony_ID, that is, Anony_ID=Anony_{—ID}_{prefix}+Anony_ID_{postfix}. The KGC signs (that is, Sign_{PrvKey}_{_{KGC}}(Anony_ID_{postfix})) the Anony_ID_{postfix}, and determines the corresponding relationship between Real_ID and Anony_ID. Then, the KGC performs Hash calculation for the Anony_ID_{prefix} to obtain the Hash value. The Hash value and the main key s of the KGC serve as the generating factors to generate part (PrvKeyₚₐᵣₜ) of the PrvKey of the client, that is, PryKeyₚₐᵣₜ=sH₁(Anony_ID_{prefix})=sH₁(H(Real_ID+RAND_{—}1)). Meanwhile, the Anony_ID serves as the public key of the client. The PrvKey may be obtained through the following formula: PrvKey=PrvKeyₚₐᵣₜ+t H₁(Anony_ID_{prefix}), among which, t is a random key selected by the client.

Step 803: The KGC sends the PrvKeyₚₐᵣₜ and Sign_{PrvKey}_{_{KGC}}(Anony_ID_{postfix}) to the client. The client needs to generate the Anony_ID and PrvKey. Until now, the client obtains the IBC public key and private key (or public and private key pair) for anonymous access. This key pair contains the binding corresponding relationship of the client acknowledged by the Access_Attribute. The public key generated by the client is Anony_ID=Anony_ID_{prefix}+Anony_ID_{postfix}. The private key is PrvKey=sH₁(Anony_ID_{prefix})+t H₁(Anony_ID_{prefix}).

Step 804: The client sends a service access request to the enabler. The access:₇T carries the parameters encrypted by using the public key Enabler_ID of the enabler, that is, Enc_{Enabler}_{_{—}}_{ID}(Anony_ID_{prefix}, Anony_ID_{postfix}, Sign_{PrvKey}(p*), KGC_URL, Sign_{PrvKey}_{_{KGC}}(Anony_ID_{postfix})). The parameters include: Anony_ID (that may be the entirety of Anony_ID_{prefix}+Anony_ID_{postfix}, Anony_ID_{prefix}, or Anony_ID_{postfix}), KGC_URL of the homing KGC claimed by the client, Sign_{PrvKey}_{_{KGC}}(Anony_ID_{postfix}), and signing value of the p* parameter by the PrvKey(Sign_{PrvKey}(p*)). The p* parameter may contain one or any combination of the Anony_ID, KGC_URL, and phase valid factor (such as the date data and counter setting) in addition to RAND_{—}2 to prevent the homing data packet or field of the p* parameter from being repeated. The Sign_{PrvKey}(p*) implies the information of transmitting the binding corresponding relationship of the client acknowledged by the Access_Attribute to the enabler, so that the enabler may verify the binding corresponding relationship.

Step 805: The enabler uses its own private key PrvKey_{Enabler} to decrypt (that is, Extract(Anony_ID_{prefix}, Anony_ID_{postfix}, KGC_URL, Sign_{PrvKey}(p*), Sign_{PrvKey}_{_{KGC}}(Anony_ID_{postfix}))) the encrypted parameter set in the access request to obtain the KGC_URL and Anony_ID (suppose that the Anony_ID contains the Access_Attribute) and check whether the KGC is trustworthy and whether the KGC is qualified to authorize the Access_Attribute. If the verification is passed, proceed with the subsequent processing. Other parameters, such as Sign_{PrvKey}(p*), may also be obtained through the decryption.

Step 806: The enabler queries the IBC public parameters of the homing KGC (indicated by the KGC_URL) of the client.

Step 807: The KGC sends the public parameters to the enabler.

If the client and the enabler belong to a same KGC, steps 806 and 807 may be skipped. If the client and the enabler belong to different KGCs, the enabler queries related information in the homing KGC by using different methods.

Step 808: After obtaining the IBC public parameter of the homing KGC of the client, the enabler judges (that is, Veri_{PrvKey}(Sign_{PrvKey}(p*))) whether the PrvKey signing is correct based on the public parameter, that is, whether the Sign_{PrvKey}(p*) is correct. If the Sign_{PrvKey}(p*) is correct, it indicates that the verification of the p* parameter signed by the PrvKey for the anonymous identity of the client is passed and that the Anony_ID is acknowledged by the KGC. In addition, the enabler needs to verify (that is, Veri_{KGC}(Sign_{PrvKey}_{_{KGC}}(Anony_ID_{postfix}))) the Sign_{PrvKey}_{_{KGC}}(Anony_ID_{postfix}). If the verification is passed, the enabler obtains the RAND_{—}2 and uses its own private key PrvKey_{Enabler} to sign the RAND_{—}2 to obtain the Sign_{PrvKey}_{_{KGC}}(RAND_{—}2) and redirects the client to the requested service according to the Access_Attribute (suppose that the Anony_ID contains the Access_Attribute). The access request of the client is processed according to the attributes indicated by the Access_Attribute. The indicated attributes, such as service, are divided into high, medium, and low levels.

Step 809: The enabler performs IBC encryption on the Sign_{PrvKey}_{_{Enabler}}(RAND_{—}2) by using the public key Anony_ID of the client to obtain the Enc_{anony}_{_{—}}_{ID}(Sign_{PrvKey}_{_{Enabler}}(RAND_{—}2)) and send it to the client to indicate that the enabler correctly receives the RAND_{—}2 and that the enabler completes authentication for the binding corresponding relationship of the client acknowledged by the Access_Attribute in step 804.

Step 810: After receiving the Enc_{anony}_{_{—}}_{ID}(Sign_{PrvKey}_{_{Enabler}}(RAND_{—}2)), the client decrypts it by using the private key PrvKey, verifies the signing of the RAND_{—}2 by using the public key Enabler_ID of the enabler, and checks whether the signing value is the RAND_{—}2 in step 804, that is, Extact&Compare(RAND_{—}2). If the signing value is the RAND_{—}2 in step 504, the client confirms that the session key used for the access is the RAND_{—}2. In this case, the access security channel with the RAND_{—}2 as the session key is considered as being established. Then the client and the enabler may exchange access information.

FIG. 8 shows a case of an IBC-based traceable anonymous access method in an embodiment of the present disclosure. When the Anony_ID contains part (suffix) of the Anony_ID provided by the client, that is, Anony_ID_{postfix}, and the Anony_ID_{postfix} may be obtained through calculation of the random key t selected by the client and the P parameter of the KGC public parameters, that is, Anony_ID_{postfix}=tP, a flow similar to that shown in FIG. 7 may be adapted to trace the real identity of the client. The random key t, however, is unknown to the KGC. The KGC needs to know the value oft to acknowledge that the Anony_ID in the anonymous access is signed by the client. If the client refuses to admit the signature in the Anony_ID on purpose (that is, the client does not inform the KGC of the value oft), the KGC needs to decrypt the value oft to obtain the real identity of the client, so that the client may not deny the signature in the Anony_ID during the anonymous access.

The system and device in an embodiment of the present disclosure are described as follows.

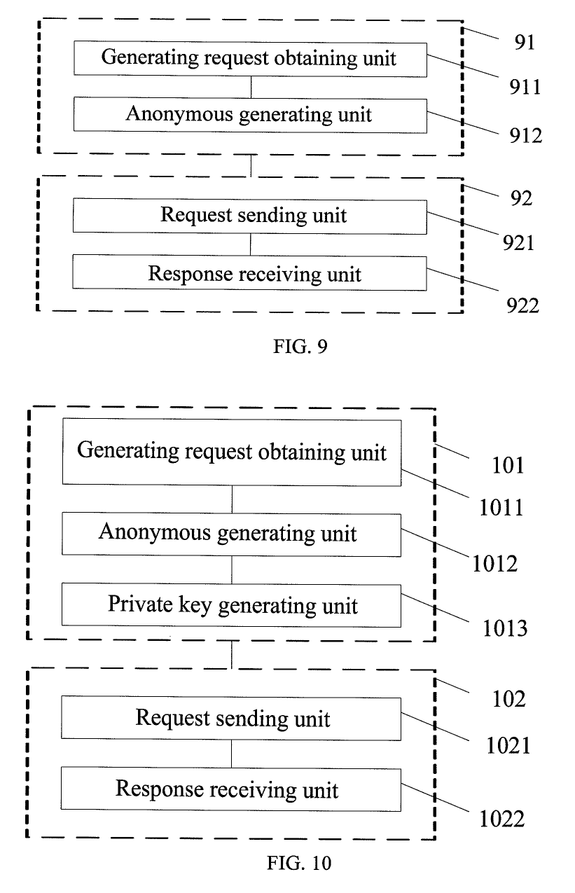

FIG. 9 shows a main structure of an identity generating system in an embodiment of the present disclosure. This system includes a service requestor identity management device KGC 91 and a service requestor device Client 92. After mutual authentication, the KGC 91 and Client 92 establish a security channel. The KGC 91 includes a generating request obtaining unit 911 and an anonymous generating unit 912. The Client 92 includes a request sending unit 921 and a response receiving unit 922. The functions of the units and devices are described as follows:

The request sending unit 921 selectively sends an Anony_ID generating request, that is, a request for generating an anonymous identity, to the KGC 91. This Anony_ID generating request may include one or any combination of the following parameters: real identity of the Client 92 (Real_ID), access attributes of the Client 92 (Access_Attribute), first random factor (RAND_{—}1), and part of the Anony_ID provided by the Client 92 (Anony_ID_{postfix}). Among these parameters, the Access_Attribute parameter may contain the information about the enabler to be accessed, that is, Enabler_ID, such as the Uniform Resource Locator (URL) of the enabler (Enabler_URL). The Access_Attribute parameter may contain the information about the access level of the service. The Anony_ID_{postfix} parameter may be obtained by calculating the random key t (a parameter similar to the main key s of the KGC) selected by the Client 92 and the P parameter of the KGC 91 public parameters (the meanings of the public parameters are defined on the basis of the cryptography-based discrete logarithm. These parameters are clear. The P parameter herein is the generating unit P selected by group G₁ to generate the formula P_{PUB}=sP). That is, Anony_ID_{postfix}=tP.

The response receiving unit 922 receives the response to the Anony_ID generating request.

The generating request obtaining unit 911 obtains the Anony_ID generating request sent by the request sending unit 921.

The anonymous generating unit 912 generates part or all of the Anony_ID that is related to the real identity of the Client 92 and saves the corresponding relationship between the real identity (Real_ID) and the Anony_ID for the use of tracing the real identity. The anonymous generating unit 912 may be adapted to:

generate all of the Anony_ID of the Client 92 by using the Hash algorithm with the Real_ID and RAND_{—}1 as the generating factors, that is, Anony_ID=H(Real_ID+RAND_{—}1), and determine the corresponding relationship between Real_ID and Anony_ID when the Anony_ID generating request contains the Real_ID and RAND_{—}1 of the Client 92; or

generate all of the Anony_ID of the Client 92 by using the Hash algorithm with the Real_ID, RAND_{—}1, and Access_Attribute as the generating factors and by combining the Access_Attribute after the Client 92 is verified as having the access attributes indicated by the Access_Attribute (for example, the Client 92 and the enabler are associated, that is, the enabler may provide services to the Client 92), that is, Anony_ID=Access_Attribute+H(Real_ID+RAND_{—}1), and determines the corresponding relationship between Real_ID and Anony_ID when the Anony_ID generating request contains the Real_ID, RAND_{—}1, and Access_Attribute of the Client 92; or

generate the prefix of the Anony_ID by using the preceding method after the Anony_ID_{postfix} is verified as meeting the requirement for the anonymous identity, that is, Anony_ID_{prefix}=H(Real_ID+RAND_{—}1); forms the Anony_ID by combining Anony_ID_{postfix} and Anony_ID_{prefix}, that is, Anony_ID=Anony_ID_{prefix}+Anony_ID_{postfix}; signs the Anony_ID_{postfix}, that is, Sign_{PrvKey}_{_{KGC}}(Anony_ID_{postfix}); and determines the corresponding relationship between Real_ID and Anony_ID when the Anony_ID generating request contains the Anony_ID_{postfix} provided by the Client 92; or

generate part or all of the Anony_ID that is related to the real identity of the client, or uses an identity that is not generated by the Real_ID as part or all of the Anony_ID. For example, the KGC 91 may provide an identity A (such as a certain random number generated by the KGC and a combination of a certain random number and a date). The identity A is not generated by using the Real_ID as the generating factor. In this case, the KGC 91 needs to determine only the corresponding relationship between the Real_ID and the identity A of the Anony_ID.

Until now, the KGC 91 generates part or all of the Anony_ID that is related to the real identity of the Client 92. The KGC 91 may also include a response unit, adapted to:

respond to the Anony_ID generating request of the Client 92, and send part or all of the Anony_ID that is related to the real identity to the client;

respond to the Anony_ID generating request to the Client 92, and send the Sign_{PryKey}_{_{KGC}}(Anony_ID_{postfix}) to the client to indicate that the Anony_ID_{postfix} meets the requirement for the anonymous identity when the KGC signs the Anony_ID_{postfix}; and

send an error or end message to the Client 92 when the KGC fails in the preceding processing (for example, the Client 92 is not associated with the enabler in step 102).

The system for generating the identity of the service requestor as shown in FIG. 9 helps generate, by the KGC 91, an anonymous identity that is related to the real identity according to the request for generating an anonymous identity for the Client 92, thus meeting the requirement for privacy of the Client 92 and improving user satisfaction.

FIG. 10 shows a main structure of an identity generating system in an embodiment of the present disclosure. This system includes a service requestor identity management device KGC 101 and a service requestor device Client 102. The system generates the private key PrvKey for the Client 102 when the anonymous identity of the Client 102 is generated. The system also establishes a security channel between KGC 101 and Client 102 after mutual authentication. The KGC 101 includes a generating request obtaining unit 1011, an anonymous generating unit 1012, and a private key generating unit 1013. The Client 102 includes a request sending unit 1021 and a response receiving unit 1022. The functions of the units and devices are described as follows:

The request sending unit 1021 selectively sends an Anony_ID generating request to the KGC 101. This Anony_ID generating request may contain one or any combination of the parameters as in the description of the request sending unit 921.

The response receiving unit 1022 receives the response to the Anony_ID generating request.

The generating request obtaining unit 1011 obtains the Anony_ID generating request sent by the request sending unit 1021.

The anonymous generating unit 1012 generates part or all of the Anony_ID that is related to the real identity of the Client 102 based on the Anony_ID generating request, or saves the corresponding relationship between the real identity (represented by the Real_ID) and the Anony_ID. For details, see the description of the anonymous generating unit 912.

The private key generating unit 1013 generates part or whole of the private key (PrvKey) that is related to the Anony_ID and that is adapted to represent the legal anonymous identity of the Client 102 after generating part or all of the Anony_ID that is related to the real identity of the Client 102, and uses the Anony_ID as the public key of the Client 102. The private key generating unit 1013 may be adapted to:

generate all of the Anony_ID of the client by using the Hash algorithm with Real_ID and RAND_{—}1 as the generating factors, that is, Anony_ID=H(Real_ID+RAND_{—}1); determine the corresponding relationship between Real_ID and Anony_ID; perform Hash calculation for the Anony_ID to obtain the Hash value; generate all of PrvKey of the Client 102 by using the Hash value and the main key s of the KGC 101 as the generating factors, that is, PrvKey=sH₁(Anony_ID)=sH₁(H(Real_ID+RAND_{—}1)); and use the Anony_ID as the public key of the Client 102 when the Anony_ID generating request includes Real_ID and RAND_{—}1 of the client; or

generate all of the Anony_ID of the Client 102 by using the Hash algorithm with the Real_ID, RAND_{—}1, and Access_Attribute as the generating factors and by combining the Access_Attribute after the client is verified as having the access attributes indicated by the Access_Attribute (for example, the Client 102 and the enabler are associated, that is, the enabler may provide services to the Client 102), that is, Anony_ID=Access_Attribute+H(Real_ID+RAND_{—}1); determine the corresponding relationship between Real_ID and Anony_ID; perform Hash calculation for the Anony_ID to obtain the Hash value of the Anony_ID; generate all of PryKey of the Client 102 by using the Hash value and the main key s of the KGC 101 as the generating factors, that is, PryKey=sH₁(Anony_ID)=sH₁(H(Real_ID+RAND_{—}1)); and use the Anony_ID as the public key of the Client 102 when the Anony_ID generating request contains the Real_ID, RAND_{—}1, and Access_Attribute of the Client 102; or

generate the prefix of the Anony_ID by using the preceding method after the Anony_M_{postfix} is verified as meeting the requirement for the anonymous identity (for example, the requirement for digit restriction policy), that is, Anony_ID_{prefix}=H(Real_ID+RAND_{—}1); obtain the Anony_ID by combining Anony_ID_{postfix} and Anony_ID_{prefix}, that is, Anony_ID=Anony_ID_{prefix}+Anony_ID_{postfix}; sign the Anony_ID_{postfix}, that is, Sign_{PrvKey}_{_{KGC}}(Anony_ID_{postfix}); determine the corresponding relationship between Real_ID and Anony_ID; perform Hash calculation for the Anony_ID_{prefix}; generate part of PrvKey of the Client 102 (PrvKeyₚₐᵣₜ) by using the Hash value and the main key s of the KGC 101, that is, PrvKeyₚₐᵣₜ =sH₁(Anony_ID_{prefix})=sH₁(H(Real_ID+RAND_{—}1)); and use the Anony_ID as the public key of the Client 102, that is, PrvKey=PrvKeyₚₐᵣₜ+t H₁(Anony_ID_{prefix}), in which, t is a random key selected by the Client 102 when the Anony_ID generating request contains the Anony_ID_{postfix} provided by the Client 102; or

generate part or all of the Anony_ID that is related to the real identity of the Client 102, or use an identity that is not generated by the Real_ID as part or all of the Anony_ID. For example, the KGC 101 may provide an identity A (such as a certain random number generated by the KGC 101 and a combination of a certain random number and a date). The identity A is not generated by using the Real_ID as the generating factor. In this case, the KGC 101 needs to determine only the corresponding relationship between the Real_ID and the identity A of the Anony_ID. Then, the Hash value obtained through calculation of the Anony_ID (that is, identity A) and the main key s of the KGC are used as the generating factors to generate all of PrvKey of the Client 102 (PrvKey), that is, PrvKey=sH₁(Anony_ID)=sH₁(A). Meanwhile, the Anony_ID is used as the public key of the Client 102.

Until now, the KGC 101 generates part or all of the Anony_ID that is related to the real identity of the Client 102 and part or all of the PrvKey that is related to the Anony_ID and that is adapted to represent the legal anonymous identity of the Client 102. The KGC 101 may further include a response unit, adapted to:

respond to the Anony_ID generating request of the Client 102, and send part or all of the Anony_ID that is related to the real identity and part or all of PryKey to the Client 102; or respond to the private key generating request of the Client 102 and send part or all of PryKey (but not Anony_ID) to the Client 102. The Client 102 generates the Anony_ID by using the method of generating the Anony_ID by the KGC 101. When the KGC 101 signs the Anony_ID_{postfix}, the KGC 101 sends the Sign_{PrvKey}_{_{KGC}}(Anony_ID_{postfix}) with the response to the Client 102 to indicate that the Anony_ID_{postfix} meets the requirement for the anonymous identity. In addition, when the KGC 101 fails in the preceding processing (for example, the Client 102 is not associated with the enabler), the KGC 101 sends an error or end message to the Client 102.

The identity generating system as shown in FIG. 10 helps generate, by the KGC 101, an anonymous identity for the Client 102 that is related to the real identity according to the request for generating an anonymous identity for the real identity, and generate part or whole of the private key that is related to the anonymous identity and that is adapted to indicate the legal anonymous identity of the Client 102, thus providing the anonymous identity and private key for anonymous access of the Client 102, meeting the requirement for privacy, and improving user satisfaction.

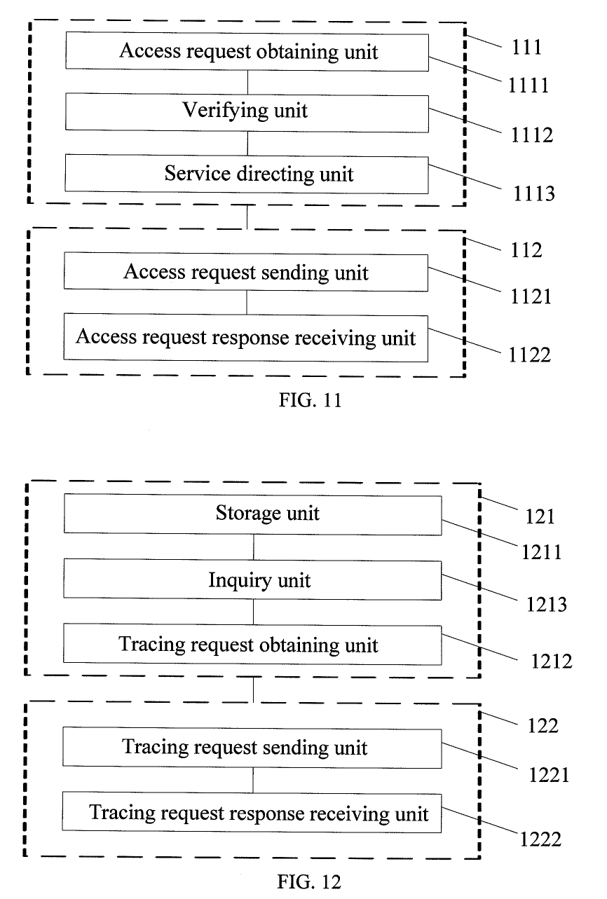

FIG. 11 shows a main structure of an access system in an embodiment of the present disclosure. This system includes a service provider device Enabler 111 and a service requestor device Client 112. The Enabler 111 includes an access request obtaining unit 1111, a verifying unit 1112, and a service redirecting unit 1113. The Client 112 includes an access request sending unit 1121 and an access request response unit 1122. The functions of the units and devices are described as follows:

The access request sending unit 1121 sends a service access request to the Enabler 111. The access request carries the Anony_ID of the Client 112 and the p* parameter, Sign_{PrvKey}(p*), that is related to the Anony_ID and that is signed by PrvKey of the Client 112 that is adapted to prove the legal anonymous identity of the Client 112. The access request may contain a second random factor (for example, RAND_{—}2, or the overall calculation result of the RAND_{—}2 and the Hash value of the Anony_ID generated by the Client 112, that is, RAND_{—}2H₁(Anony_ID)). When the Client 112 and the Enabler 111 belong to different KGCs (when the Client 112 and Enabler 111 belong to a same KGC, the information about the homing authority administrator claimed by the Client 112 may be excluded), the access request may contain the information about the homing authority administrator claimed by the Client 112, that is, the information about the KGC to which the Client 112 belongs, for example, KGC_URL. When the Anony_ID includes the Anony_ID_{prefix} generated by the KGC and Anony_ID_{postfix} provided by the Client 112, the Anony_ID may contain the access attribute information of the Client 112 (Access_Attribute). When the Anony_ID includes the Anony_ID_{postfix}, the access request may contain the information signed by the KGC for the Anony_ID_{postfix}(Sign_{PrvKey}_{_{KGC}}(Anony_ID_{postfix})). In addition to the second random factor, the p* parameter may contain one or any combination of Anony_ID, KGC_URL, and phase effective factor (such as the date data and counter setting), thus preventing the data packet or field of the p* parameter from being repeated.

The access request response receiving unit 1122 receives the response to the access request.

The access request obtaining unit 1111 obtains the access request from the Client 112.

The verifying unit 1112 verifies the p* parameter signed by the PrvKey for the anonymous identity of the Client 112 according to the access request. After extracting the related parameters from the access request, the verifying unit 1112 obtains the public parameter of the KGC and judges whether the PrvKey signing is correct based on the public parameter. If the PrvKey signing is correct, the verification of the p* parameter signed by the PrvKey for the anonymous identity of the Client 112 is passed.

The Enabler 111 may include a preliminary verifying unit with the following function: When the access request contains the KGC_URL, and the Anony_ID contains the Access_Attribute of the Client 112, the following procedure may be included in addition to the verification of the p* parameter signed by PrvKey for the anonymous identity of the Client 112: The KGC is verified according to the KGC_URL and Access_Attribute and for the authorization qualification of the Access_Attribute. If the verification is passed, the verification of the p* parameter signed by PrvKey for the anonymous identity of the Client 112 is triggered.

In addition, the Enabler 111 may include a part verifying unit with the following function: When the Anony_ID contains part of the Anony_ID provided by the Client 112 and the homing KGC claimed by the Client 112 signs part of the Anony_ID provided by the Client 112, part of the Anony_ID provided by the Client 112 is verified during the verification of the p* parameter signed by PrvKey for the anonymous identity of the Client 112.

Until now, the Client 112 and the Enabler 111 complete verifying the anonymous identity of the Client 112.

The Enabler 111 may include a key negotiating unit with the following function: When the p* parameter contains the second random factor, the third random factor is set and signed for determining the session key used by the access based on the second random factor after the verification of the p* signed by PrvKey for the anonymous identity of the Client 112 is passed. When the verification of the signing of the third random factor by the Client 112 is passed, the third random factor is adapted to determine the session key used by the access. When the p* parameter contains the second random factor RAND_{—}2, the third random factor that is adapted to determine the session key used by the access is RAND_{—}2 after the verification of the p* signed by PrvKey for the anonymous identity of the Client 112 is passed. The RAND_{—}2 is signed by using the private key PrvKey_{Enabler} of the Enabler 111 to obtain the signing value Sign_{PrvKey}_{_{Enabler}}(RAND_{—}2). After receiving the Sign_{PrvKey}_{_{Enabler}}(RAND_{—}2) sent by the Enabler 111, the session key used for the access is RAND_{—}2 when the verification of the Sign_{PrvKey}_{_{Enabler}}(RAND_{—}2) by the Client 112 is passed (the obtained signed RAND_{—}2 is the second random factor RAND_{—}2 sent in step 301). At this time, an access security channel with RAND_{—}2 as the session key is considered as being established. The Client 112 and the Enabler 111 may exchange access information. When the second random factor contained in the p* parameter is an overall calculation result of the RAND_{—}2 and the Hash value of the Anony_ID generated by the Client 112, that is, RAND_{—}2H₁(Anony_ID), the third random factor that is adapted to determine the session key used by the access is the overall calculation result of the RAND_{—}3 and the Hash value of the Enabler_ID provided by the Enabler 111, that is, RAND_{—}3H₁(Enabler_ID), after the verification of the p* signed by PrvKey for the anonymous identity of the Client 112 is passed. The RAND_{—}3H₁(Enabler_ID) is signed by using the private key PrvKey_{Enabler} of the Enabler 111 to obtain the signing value Sign_{PrvKey}_{_{Enabler}}(RAND_{—}3H₁(Enabler_ID)). After receiving the Sign_{PrvKey}_{_{Enabler}}(RAND_{—}3H₁(Enabler_ID)) from the Enabler 111, the Client 112 confirms that the session key used for the access is Key_{Client-Enabler}=ê(PrvKey, RAND_{—}3H₁(Enabler_ID)+RAND_{—}2H₁(Enabler_ID)) when the verification of the Sign_{PrvKey}_{_{Enabler}}(RAND_{—}3H₁(Enabler_ID) by the Client 112 is passed (that is, the obtained signed RAND_{—}3H₁(Enabler_ID) is the comparison value RAND_{—}3H₁(Enabler_ID) carried in the access request). The Enabler 111 confirms that the session key used for the access is Key_{Enabler-Client}=ê(PrvKey_{Enabler}, RAND_{—}2H₁(Anony_ID)+RAND_{—}3H₁(Anony_ID)). At this time, an access security channel with Key_{Client-Enabler}=Key_{Enabler-Client} as the session key is established. Then the Client 112 and the Enabler 111 may exchange access information.

Until now, the Client 112 and the Enabler 111 complete negotiation for the session key of the access.

The access system as shown in FIG. 11 helps access the service by using the anonymous identity and the parameter signed by the private key of the Client 112 that is related to the anonymous identity and that is adapted to indicate the legal anonymous identity of the Client 112 and redirect the Client 112 to the requested service when the verification, by the Enabler 111, of the parameter signed by the private key for the anonymous identity of the Client 112, thus enabling anonymous access of the Client 112, meeting the requirement for the privacy of the Client 112, and improving user satisfaction.

FIG. 12 shows a main structure of an identity tracing system in an embodiment of the present disclosure. This system includes a service requestor identity management device KGC 121 and an identity tracing request device Enabler 122. The KGC 121 includes a storage unit 1211, a tracing request obtaining unit 1212, and an inquiry unit 1213. The Enabler 122 includes a tracing request sending unit 1221 and a tracing request response receiving unit 1222. The functions of the units and devices are described as follows:

The tracing request sending unit 1221 sends the request (with the Anony_ID provided by the client) for tracing the real identity of the client that accesses the service anonymously to the KGC 121. That is, the Enabler 122 applies an arbitration voucher (that may be carried in the tracing request) from the arbiter for tracing the real identity of the client to request the KGC 121 for providing the real identity of the client before the tracing request is sent. The Enabler 122 may provide the access record (or transaction record) of the client.

The tracing request response receiving unit 1222 receives the response of the KGC 121 to the tracing request.

The storage unit 1211 stores the corresponding relationship between the real identity of the client and the Anony_ID that is adapted to hide the real identity.

The tracing request obtaining unit 1212 obtains the request of the Enabler 122 for tracing the real identity of the service access party.

The inquiry unit 1213 queries the corresponding relationship between the real identity of the client and the Anony_ID that is adapted to hide the real identity of the client according to the tracing request (that may carry the Anony_ID provided by the client and the arbitration voucher) sent by the Enabler 122 and obtains the real identity of the client. That is, the inquiry unit proves the authenticity of the arbitration voucher from the arbiter. When the arbitration voucher is proven authentic, the inquiry unit queries the real identity of the client.

The identity tracing system as shown in FIG. 12 queries the corresponding relationship between the real identity of the client and the Anony_ID that is adapted to hide the real identity, obtains the real identity of the client, and responds to the tracing request according to the request for tracing the real identity of the client, thus obtaining the real identity of the client when necessary so that the client may not deny the initiated service access.

The preceding are the main structures of the systems and devices provided in an embodiment of the present disclosure. The applications using the system and device functions are described as follows:

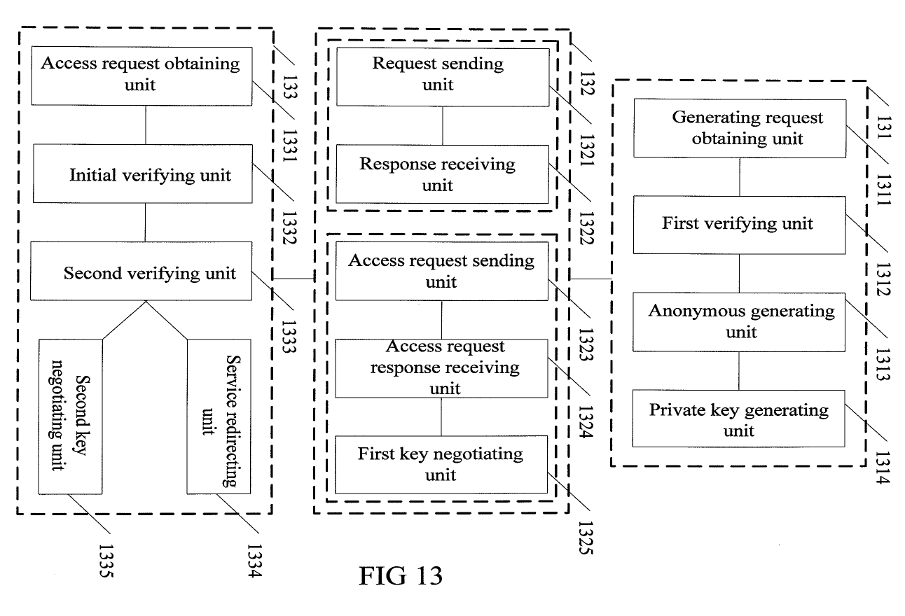

FIG. 13 shows an IBC-based traceable anonymous access system in an embodiment of the present disclosure. This system includes the KGC 131, Client 132, and Enabler 133. The KGC 131 includes a generating request obtaining unit 1311, a first verifying unit 1312, an anonymous generating unit 1313, and a private key generating unit 1314. The Client 132 includes a request sending unit 1321, a response receiving unit 1322, an access request sending unit 1323, an access request response receiving unit 1324, and a first key negotiating unit 1325. The Enabler 133 includes an access request obtaining unit 1331, an initial verifying unit 1332, a second verifying unit 1333, a service redirecting unit 1334, and a second key negotiating unit 1335. The functions of the units and devices are described as follows:

The request sending unit 1321 sends a request to the KGC 131 for obtaining the public key and private key used in anonymous access. This request may also serve as the request for generating the anonymous identity for the Client 132. The request contains the following parameters: Access_Attribute (access attribute information of the Client 132 that may contain the information about the requested Enabler 133, that is, Enabler_ID, such as Enabler_URL), RAND_{—}1, and Real_ID.

The first verifying unit 1312 queries the Enabler 133 based on the Access_Attribute parameter (such as Enabler_URL) to check whether the Client 132 has the access attributes indicated by the Access_Attribute.

The first verifying unit 1312 may include:

a judging unit, adapted to judge whether the Client 132 is associated with the Enabler 133 based on the Real_ID and Enabler_URL, that is, whether the Enabler 133 may provide services to the Client 132; and

a judging processing unit, adapted to activate the anonymous generating unit 1313 when the judging unit judges that the Client 132 is associated with the Enabler 133.

The anonymous generating unit 1313 generates the Hash value for the RAND_{—}1 and Real_ID in the request by using a Hash algorithm (such as MD5 and SHA_{—}1) when the first verifying unit 1312 is passed, that is, hides the real identity of the Client 132; use the Hash value, H(Real_ID+RAND_{—}1), and the Access_Attribute to form the anonymous identity, that is, Anony_ID=Access_Attribute+H(Real_ID+RAND_{—}1), that serves as the public key for the Client 132 that uses the IBC-based traceable anonymous access method.

The private key generating unit 1314 uses the public key Anony_ID to generate the private key PrvKey that is related to the Anony_ID and that is adapted to prove the legal anonymous identity of the Client 132, that is, PrvKey=sH₁(Anony_ID)=sH₁(Access_Attribute+H(Real_ID+RAND_{—}1)), which indicates that the KGC 131 acknowledges the Access_Attribute of the Client 132 and implicitly binds the acknowledged corresponding relationship in the PrvKey.

The response receiving unit 1322 receives the PrvKey related to the Anony_ID sent by the KGC 131 through the security channel. When this function is complete, it indicates that the Client 132 has obtained the authorization of the KGC 131 for the anonymous access to the service. The PryKey indicates the acknowledgement of the anonymous access right. The value signed by using the PrvKey (encrypted by the PrvKey) may be decrypted by using only the Anony_ID.

The public key Anony_ID of the Client 132 may be generated by using the similar method of the KGC 131.

The KGC 131 may use other methods to generate the PrvKey related to the Anony_ID. However, the real identity of the client must be uniquely mapped to the Anony_ID.

The access request sending unit 1323 sends a service access request that carries the parameters encrypted by using the public key Enabler_ID of the Enabler 133, that is, Enc_{Enabler}_{_{—}}_{ID}(Anony_ID+KGC_URL+RAND_{—}2+Sign_{PrvKey}(p*)), to the Enabler 133. The parameters include: Anony_ID (that is, Access_Attribute+H(Real_ID+RAND_{—}1), KGC_URL of the homing KGC claimed by the client, RAND_{—}2, and signing value of the p* parameter by the PrvKey(Sign_{PrvKey}(p*)). The p* parameter may contain one or any combination of the Anony_ID, KGC_URL, and phase valid factor (such as the date data and counter setting) in addition to RAND_{—}2 to prevent the homing data packet or field of the p* parameter from being repeated. The Sign_{PrvKey}(p*) implicitly transmits the acknowledged binding corresponding relationship of the Access_Attribute of the client to the Enabler 133, so that the Enabler 133 may verify the binding corresponding relationship.

The access request obtaining unit 1331 obtains the access request from the Client 132.

The initial verifying unit 1332 checks whether the KGC is trustworthy and whether the KGC is qualified to authorize the Access_Attribute after using its own private key PrvKey_{Enabler} to decrypt the encrypted parameter set in the access request and extracts the parameter through resolution, that is, Extract(KGC_URL+Access_Attribute), and obtain the KGC_URL and Anony_ID (that contains the Access_Attribute). If the verification is passed, proceed with the subsequent processing. Other parameters, such as Sign_{PrvKey}(p*), may also be obtained through the decryption.

The public parameter obtaining unit of the second verifying unit 1333 queries and obtains the IBC public parameter (such as Anony_ID) of the homing KGC 131 (with the related KGC_URL) of the Client 132. If the Client 132 and the Enabler 133 belong to a same KGC 131, the public parameter obtaining unit does not need to transmit related parameters. If the Client 132 and the Enabler 133 belong to different KGCs, the public parameter obtaining unit queries related parameters to the homing KGC by using different methods.

The judging unit of the second verifying unit 1333 obtains the public parameter of the homing KGC 131 of the Client 132 and judges (that is, Veri_{Anony}_{_{—}}_{ID}(Sign_{PrvKey}(p*))) whether the PryKey signing is correct, that is, whether the Sign_{PrvKey}(p*) is correct. If the Sign_{PrvKey}(p*) is correct, it indicates that the verification of the p* parameter signed by the PryKey for the anonymous identity of the Client 132 is passed and that the Anony_ID is acknowledged by the KGC 131.

The service redirecting unit 1334 redirects the Client 132 to the requested service according to the Access_Attribute when the verification by the second verifying unit 1333 is passed, and processes the access of the Client 132 according to the attributes indicated by the Access_Attribute. The indicated attributes are divided into high, medium, and low levels.

The second key negotiating unit 1335 performs IBC encryption on the Sign_{PrvKey}_{_{Enabler}}(RAND_{—}2) by using the public key Anony_ID of the Client 132 to obtain the Enc_{anony}_{_{—}}_{ID}(Sign_{PrvKey}_{_{Enabler}}(RAND_{—}2)) and send it to the Client 132 to indicate that the Enabler 133 correctly receives the RAND_{—}2 and that the Enabler 133 completes authentication for the binding corresponding relationship of the Client 132 acknowledged by the Access_Attribute after the verification by the second verifying unit 1333 is passed.

The access request response receiving unit 1324 receives the response to the access request, which carries the Enc_{anony}_{_{—}}_{ID}(Sign_{PrvKey}_{_{Enabler}}(RAND_{—}2)).

After receiving the Enc_{anony}_{_{—}}_{ID}(Sign_{PrvKey}_{_{Enabler}}(RAND_{—}2)), the first key negotiating unit 1325 decrypts (Extact(Sign_{PrvKey}_{_{Enabler}}(RAND_{—}2))) it by using the private key PrvKey, verifies (Veri_{Enabler}_{_{—}}_{ID}(Sign_{PrvKey}_{_{Enabler}}(RAND_{—}2))) the signing of the RAND_{—}2 by using the public key Enabler_ID of the Enabler 133, and checks whether the signing value is the RAND_{—}2 sent by the access request sending unit 1323. If the signing value is the RAND_{—}2 sent by the access request sending unit 1323, the first key negotiating unit 1325 confirms that the session key used for the access is the RAND_{—}2. In this case, the access security channel with the RAND_{—}2 as the session key is considered as being established. Then the Client 132 and the Enabler 133 may exchange access information.

The following IBC-based traceable anonymous access system may serve as an alternative of the functions of certain preceding units:

The access request sending unit 1323 sends a service access request to the Enabler 133. The access request carries the parameters encrypted by using the public key Enabler_ID of the Enabler 133, that is, Enc_{Enabler}_{_{—}}_{ID}(Anony_ID+KGC_URL+RAND_{—}2H₁(Anony_ID)+Sign_{PrvKey}(p*)). The parameters include: Anony_ID (that is, Access_Attribute+H(Real_ID+RAND_{—}1)), KGC_URL of the homing KGC claimed by the Client 132, and overall calculation result of the RAND_{—}2 and the Has value of the Anony_ID generated by the Client 132 (that is, RAND_{—}2H₁(Anony_ID)), and signing value of the p* parameter by the PryKey(Sign_{PrvKey}(p*)). The p* parameter may contain one or any combination of the Anony_ID, KGC_URL, and phase valid factor (such as the date data and counter setting) in addition to RAND_{—}2H₁(Anony_ID) to prevent the homing data packet or field of the p* parameter from being repeated. The Sign_{PrvKey}(p*) implies the information of transmitting the binding corresponding relationship of the Client 132 acknowledged by the Access_Attribute to the Enabler 133, so that the Enabler 133 may verify the binding corresponding relationship.

The access request obtaining unit 1331 obtains the access request from the Client 132.

The initial verifying unit 1332 checks whether the KGC is trustworthy and whether the KGC is qualified to authorize the Access_Attribute after using its own private key PrvKey_{Enabler} to decrypt the encrypted parameter set in the access request and extracts the parameter through resolution, that is, Extact(Sign_{PryKey}_{_{Enabler}}(RAND_{—}3H(Enabler_ID))), and obtain the KGC_URL and Anony_ID (that contains the Access_Attribute). If the verification is passed, proceed with the subsequent processing. Other parameters, such as Sign_{PrvKey}(p*), may also be obtained through the decryption.

The public parameter obtaining unit of the second verifying unit 1333 queries and obtains the IBC public parameter (such as Anony_ID) of the homing KGC 131 (with the related KGC_URL) of the Client 132. If the Client 132 and the Enabler 133 belong to a same KGC 131, the public parameter obtaining unit does not need to transmit related parameters. If the Client 132 and the Enabler 133 belong to different KGCs, the public parameter obtaining unit queries related parameters to the homing KGC by using different methods.

The judging unit of the second verifying unit 1333 obtains the public parameter of the homing KGC 131 of the Client 132 and judges whether the PrvKey signing is correct, that is, whether the Sign_{PrvKey}(p*) is correct. If the Sign_{PrvKey}(p*) is correct, it indicates that the verification of the p* parameter signed by the PrvKey for the anonymous identity of the Client 132 is passed and that the Anony_ID is acknowledged by the KGC 131.

The service redirecting unit 1334 redirects the Client 132 to the requested service according to the Access_Attribute when the verification by the second verifying unit 1333 is passed, and processes the access of the Client 132 according to the attributes indicated by the Access_Attribute. The indicated attributes are divided into high, medium, and low levels.

The second key negotiating unit 1335, when the verification by the second verifying unit 1333 is passed, extracts the RAND_{—}2H₁(Anony_ID), uses the method similar to that for generating RAND_{—}2H₁(Anony_ID) by the Client 132 to generate the overall calculation method of the Hash value of the RAND_{—}3 provided by the Enabler 133 and the Enabler_ID, that is, RAND_{—}3H₁(Enabler_ID), uses the private key PrvKey_{Enabler} of the Enabler 133 to sign the RAND_{—}3H₁(Enabler_ID) to obtain the signing value Sign_{PrvKey}(RAND_{—}3H₁(Enabler_ID)), and Enabler performs IBC encryption for the Sign_{PrvKey}_{_{Enabler}}(RAND_{—}3H₁(Enabler_ID)) by using the public key Anony_ID of the Client 132 to obtain the Enc_{anony}_{_{—}}_{ID}(RAND_{—}3H₁(Enabler_ID)+Sign_{PrvKey}_{_{Enabler}}(RAND_{—}3H₁(Enabler_ID))). Then the second key negotiating unit 1335 sends the Enc_{anony}_{_{—}}_{ID}(RAND_{—}3H₁(Enabler_ID)+Sign_{PrvKey}(RAND_{—}3H₁(Enabler_ID))) to the Client 132 to indicate that the Enabler 133 correctly receives the RAND_{—}2H₁(Anony_ID) and that the Enabler 133 completes authentication for the binding corresponding relationship of the Client 132 acknowledged by the Access_Attribute.

The access request response receiving unit 1324 receives the response to the access request, which carries the Enc_{anony}_{_{—}}_{ID}(RAND_{—}3H₁(Enabler_ID)+Sign_{PrvKey}_{_{Enabler}}(RAND_{—}3H₁(Enabler_ID))).

After receiving the Enc_{anony}_{_{—}}_{ID}(RAND_{—}3H₁(Enabler_ID)+Sign_{PrvKey}_{_{Enabler}}(RAND_{—}3H₁(Enabler_ID))), the first key negotiating unit 1325 decrypts it by using the private key PrvKey, verifies the signing of the RAND_{—}2 by using the public key Enabler_ID of the Enabler 133, and checks whether the signing value is the RAND_{—}3H₁(Enabler_ID) sent by the access request sending unit 1323. If the signing value is the RAND_{—}3H₁(Enabler_ID), it is regarded that the related parameters sent by the Client 132 are correctly received and that the anonymous identity of the Client 132 is legal. The Client 132 confirms that the session key used by the access is Key_{Client-Enabler}=ê(PrvKey, RAND_{—}3H₁(Enabler_ID)_RAND_{—}2H₁(Enabler_ID)). The Enabler 133 confirms that the session key used by the access is Key_{Enabler-Client}=ê(PrvKey_{Enabler}, RAND_{—}2H₁(Anony_ID)+RAND_{—}3H₁(Anony_ID)). In this case, the access security channel with the RAND_{—}2 as the session key is considered as being established. Then the Client 132 and the Enabler 133 may exchange access information.

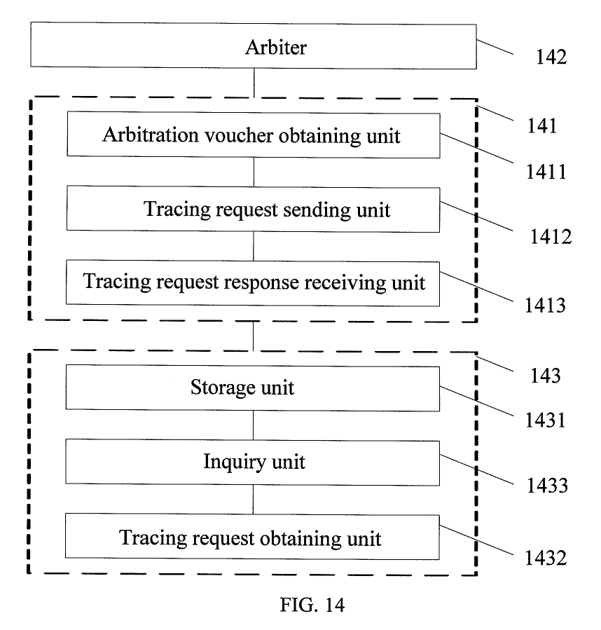

FIG. 14 is an identity tracing system provided in an embodiment of the present disclosure. This system includes the Enabler 141, Arbiter 142, and KGC 143. The Enabler 141 includes an arbitration voucher obtaining unit 1411, a tracing request sending unit 1412, and a tracing request response receiving unit 1413. The KGC 143 includes a storage unit 1431, a tracing request obtaining unit 1432, and an inquiry unit 1433. The functions of the units and devices are described as follows:

The arbitration voucher obtaining unit 1411 applies the Arbiter 142 for the arbitration voucher for tracing the real identity of the client and provides the access record or transaction record of the anonymous access of the client. The access record includes the relevant record about the signing of the client using the Anony_ID. After the Arbiter 142 reviews the access record provided by the Enabler 141 about the client and Anony_ID signing and decides to arbitrate the Anony_ID, the arbitration voucher obtaining unit 1411 obtains the arbitration voucher from the Arbiter 142 for tracing the real identity of the client.

After obtaining the arbitration voucher, the tracing request sending unit 1412 provides the KGC 143 with the request for tracing the real identity of the client that contains the arbitration voucher and the Anony_ID to ask the KGC 143 to provide the real identity of the client that is related to the Anony_ID.

The storage unit 1431 stores the corresponding relationship between the real identity of the client and the Anony_ID that is adapted to hide the real identity.

The tracing request obtaining unit 1432 obtains the request of the Enabler 141 for tracing the real identity of the client that accesses the service anonymously.

The inquiry unit 1433 queries the record about the Anony_ID generating request of the client, informs the client of the arbitration event of the Arbiter 142, and verifies the arbitration voucher with the Aribter 142 according to the tracing request sent by the Enabler 141. When the Arbiter 142 returns that the arbitration voucher is authentic, the inquiry unit 1433 queries the corresponding relationship between the real identity of the client and the Anony_ID that is adapted to hide the real identity of the client to obtain the real identity of the client and send the real identity to the Enabler 141.

The identity tracing system may be adapted to verify the real identity of the client when necessary. The arbitration process involves non-technical aspects that are not described herein.

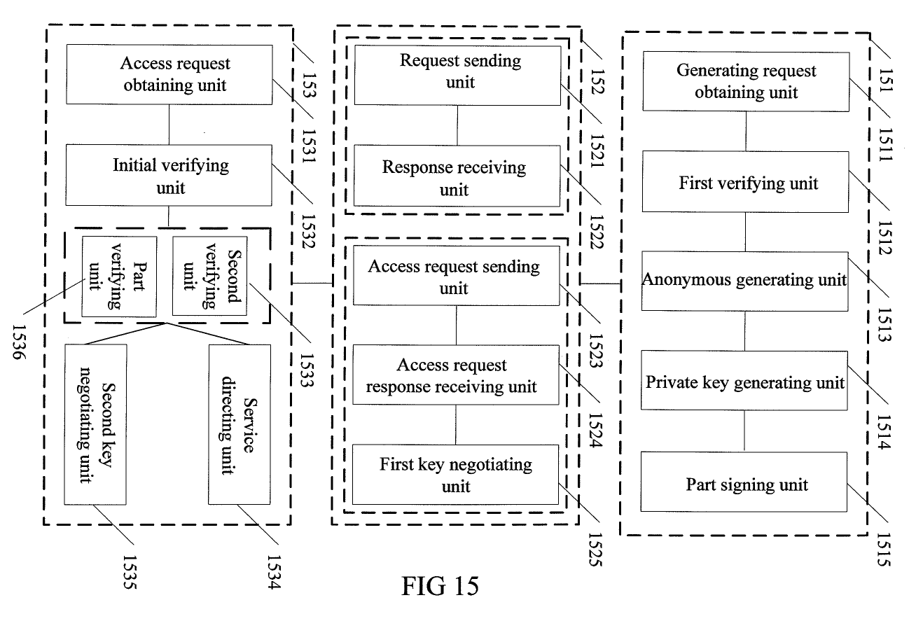

FIG. 15 shows an IBC-based traceable anonymous access system in an embodiment of the present disclosure in the case when the client needs to participate in generating the anonymous identity and private key of the client. This system includes the KGC 151, Client 152, and Enabler 153. The KGC 151 includes a generating request obtaining unit 1511, a first verifying unit 1512, an anonymous generating unit 1513, a private key generating unit 1514, and a part signing unit 1515. The Client 132 includes a request sending unit 1521, a response receiving unit 1522, an access request sending unit 1523, an access request response receiving unit 1524, and a first key negotiating unit 1525. The Enabler 133 includes an access request obtaining unit 1531, an initial verifying unit 1532, a second verifying unit 1533, a service redirecting unit 1534, a second key negotiating unit 1535, and a part verifying unit 1536. The functions of the units and devices are described as follows:

The request sending unit 1521 sends a request to the KGC 151 for obtaining the public key and private key used for the anonymous access of the Client 152. This request includes RAND_{—}1, Real_ID (real identity of the Client 152), and part (suffix) of the Anony_ID provided by the Client 152 (that is, Anony_ID_{postfix}). The Anony_ID_{postfix} may be obtained through calculation of the random key t selected by the Client 152 and P in the KGC 151 public parameter, that is, Anony_ID_{postfix}=tP. In step 801, the Client 152 may contain only the anonymous access request that carries tP. The request may contain information such as the Access_Attribute. The following flow takes the scenario when the Access_Attribute information is contained as an example. The following flow, however, is applicable to the scenarios when other information is contained.

The first verifying unit 1512 checks whether the Anony_ID_{postfix} meets the requirement for the digit restriction policy and whether the Client 152 has the access attributes indicated by the Access_Attribute (for example, the Client 152 is associated with the Enabler 153, that is, the Enabler 153 may provide services to the Client 152).

The anonymous generating unit 1513, when the verification by the first verifying unit 1512 is passed, generates part (prefix) Anony_ID_{prefix}=H(Real_ID+RAND_{—}1) of the Anony_ID, obtains the Anony_ID by combining Anony_ID_{postfix} and Anony_ID_{prefix}, that is, Anony_ID=Anony_ID_{prefix}+Anony_ID_{postfix}, and determines the corresponding relationship between Real_ID and Anony_ID.

The part signing unit 1515, when the verification by the first verifying unit 1512 is passed, signs the Anony_ID_{postfix}, that is, Sign_{PrvKey}_{_{KGC}}(Anony_ID_{postfix}).

The private key generating unit 1514 obtains the Hash value of the Anony_ID_{prefix} through Hash calculation, generates part (PrvKeyₚₐᵣₜ) of the PrvKey of the Client 152 by using the Hash value and the main key s of the KGC 151 as the generating factors, that is, PrvKeyₚₐᵣₜ=sH₁(Anony_ID_{prefix})=sH₁(H(Real_ID+RAND_{—}1)), and uses the Anony_ID as the public key of the Client 152. The PrvKey may be obtained through the following formula: PrvKey=PrvKeyₚₐᵣₜ+t H₁(Anony_ID_{prefix}). In the formula, t is the random key selected by the Client 152.

The response receiving unit 1522 receives the PrvKeyₚₐᵣₜ and Sign_{PrvKey}_{_{KGC}}(Anony_ID_{postfix}) from the KGC 151. Until now, the Client 151 obtains the IBC public key and private key (or public and private key pair) for anonymous access. This key pair contains the binding corresponding relationship of the Client 152 acknowledged by the Access_Attribute. The public key generated by the Client 152 is Anony_ID=Anony_ID_{prefix}+Anony_ID_{postfix}. The private key is PrvKey=sH₁(Anony_ID_{prefix})+t H₁(Anony_ID_{prefix}).

The access request sending unit 1523 sends a service access request to the Enabler 153. The access request carries the parameters encrypted by using the public key Enabler_ID of the Enabler 153, that is, Enc_{Enabler}_{_{—}}_{ID}(Anony_ID_{prefix}, Anony_ID_{postfix}, Sign_{PrvKey}(p*), KGC_URL, Sign_{PrvKey}_{_{KGC}}(Anony_ID_{postfix})). The parameters include: Anony_ID (that may be the entirety of Anony_ID_{prefix}+Anony_ID_{postfix}, Anony_ID_{prefix}, or Anony_ID_{postfix}), KGC_URL of the homing KGC claimed by the Client 152, Sign_{PrvKey}_{_{KGC}}(Anony_ID_{postfix}), and signing value of the p* parameter by the PryKey(Sign_{PrvKey}(p*)). The p* parameter may contain one or any combination of the Anony_ID, KGC_URL, and phase valid factor (such as the date data and counter setting) in addition to RAND_{—}2 to prevent the homing data packet or field of the p* parameter from being repeated. The Sign_{PrvKey}(p*) implies the information of transmitting the binding corresponding relationship of the Client 152 acknowledged by the Access_Attribute to the Enabler 153, so that the Enabler 153 may verify the binding corresponding relationship.

The access request obtaining unit 1531 obtains the access request from the Client 152.

The initial verifying unit 1532 uses its own private key PrvKey_{Enabler} to decrypt (that is, Extract(Anony_ID_{prefix}, Anony_ID_{postfix}, KGC_URL, Sign_{PrvKey}(p*), Sign_{PrvKey}_{_{KGC}}(Anony_ID_{postfix}))) the encrypted parameter set in the access request to obtain the KGC_URL and Anony_ID (suppose that the Anony_ID contains the Access_Attribute) and check whether the KGC 151 is trustworthy and whether the KGC 151 is qualified to authorize the Access_Attribute. If the verification is passed, proceed with the subsequent processing. Other parameters, such as Sign_{PrvKey}(p*), may also be obtained through the decryption.

The public parameter obtaining unit of the second verifying unit 1533 queries and obtains the IBC public parameter (such as Anony_ID) of the homing KGC 151 (with the related KGC_URL) of the Client 152. If the Client 152 and the Enabler 153 belong to a same KGC 151, the public parameter obtaining unit does not need to transmit related parameters. If the Client 152 and the Enabler 153 belong to different KGCs, the public parameter obtaining unit queries related parameters to the homing KGC by using different methods.

The judging unit of the second verifying unit 1533 obtains the public parameter of the homing KGC 151 of the Client 152 and judges (that is, Veri_{PrvKey}(Sign_{PrvKey}(p*))) whether the PrvKey signing is correct, that is, whether the Sigh_{PrvKey}(p*) is correct. If the Sign_{PrvKey}(p*) is correct, it indicates that the verification of the p* parameter signed by the PrvKey for the anonymous identity of the Client 152 is passed and that the Anony_ID is acknowledged by the KGC 151.

The part verifying unit 1536 verifies the Sign_{PrvKey}_{_{KGC}}(Anony_ID_{postfix}), that is, Veri_{KGC}(Sign_{PrvKey}_{_{KGC}}(Anony_ID_{postfix})), during the verification of the second verifying unit 1533.

The service redirecting unit 1534 redirects the Client 152 to the requested service according to the Access_Attribute (suppose that the Anony_ID contains the Access_Attribute) when the verification by the second verifying unit 1533 is passed, and processes the access of the Client 152 according to the attributes indicated by the Access_Attribute. The indicated attributes are divided into high, medium, and low levels.

The second key negotiating unit 1535 performs IBC encryption on the Sign_{PrvKey}_{_{Enabler}}(RAND_{—}2) by using the public key Anony_ID of the client to obtain the Enc_{anony}_{_{—}}_{ID}(Sign_{PrvKey}_{_{Enabler}}(RAND_{—}2)) and send it to the Client 152 to indicate that the Enabler 153 correctly receives the RAND_{—}2 and that the Enabler 153 completes authentication for the binding corresponding relationship of the Client 152 acknowledged by the Access_Attribute after the verification by the second verifying unit 1533 and the verification by the part verifying unit 1536 are passed.

The access request response receiving unit 1524 receives the response to the access request, which carries the Enc_{anony}_{_{—}}_{ID}(Sign_{PrvKey}_{_{Enabler}}(RAND_{—}2)).

After receiving the Enc_{anony}_{_{—}}_{ID}(Sign_{PrvKey}_{_{Enabler}}(RAND_{—}2)), the first key negotiating unit 1525 decrypts (that is, Extact&Compare(RAND_{—}2)) it by using the private key PrvKey, verifies the signing of the RAND_{—}2 by using the public key Enabler_ID of the Enabler 153, and checks whether the signing value is the RAND_{—}2 sent by the access request sending unit 1523. If the signing value is the RAND_{—}2 sent by the access request sending unit 1523, the first key negotiating unit 1525 confirms that the session key used for the access is the RAND_{—}2. In this case, the access security channel with the RAND_{—}2 as the session key is considered as being established. Then the Client 152 and the Enabler 153 may exchange access information.

FIG. 15 shows a case of an IBC-based traceable anonymous access system in an embodiment of the present disclosure. When the Anony_ID contains part (suffix) of the Anony_ID provided by the Client 152, that is, Anony_ID_{postfix}, and the Anony_ID_{postfix} may be obtained through calculation of the random key t selected by the Client 152 and the P parameter of the KGC public parameters, that is, Anony_ID_{postfix}=tP, a flow similar to that shown in FIG. 12 may be adapted to trace the real identity of the Client 152. The random key t, however, is unknown to the KGC 151. The KGC 151 needs to know the value of t to acknowledge that the Anony_ID in the anonymous access is signed by the Client 152. If the Client 152 refuses to admit the signature in the Anony_ID on purpose (that is, the Client 152 does not inform the KGC 151 of the value of t), the KGC needs to decrypt the value oft to obtain the real identity of the Client 152, so that the Client 152 may not deny the signature in the Anony_ID during the anonymous access.

The present disclosure may be flexibly applied in actual situations, including but not limited to the following.

### A. Anonymous Auction

In certain online auction, a bidder (similar to the client in the present disclosure) usually is reluctant to unveil their personal information. That is, the bidder does not want the auctioneer (similar to the enabler in the present disclosure) to know its identity. In addition, the bidder does not want to show its real identity during the auction. The bidder wants to protect its privacy of real identity, while the auctioneer requires that the bidder has certain clear identity to ensure that the auction is successful. If the scheme provided in the present disclosure is used, the bidder may obtain an anonymous identity that is related to its real identity from an authorized third party (similar to the KGC in the present disclosure), and use this anonymous identity to participate in the auction (that is, the access method in the present disclosure). When a deal is made, the bidder does not need to provide its real identity to complete the auction. If the bidder does not pay the bid after winning the bid and denies that it participates in the auction, the anonymous identity may be used to trace its real identity (that is, the method for tracing the real identity of the service requestor in the present disclosure).

### B. Tiered Access

When finding that the second service provider (similar to the enabler in the present disclosure) provides a new service, the first service provider (similar to the KGC in the present disclosure) does not want to establish a same system to provide the new service to its own users (similar to the client in the present disclosure) but wants its own users to use the new service provided by the second service provider to enrich its service types. At the same time, the first service provider does not want the second service provider to know the real identities of the users of the first service provider. In this case, the scheme provided in the present disclosure may be adopted. The first service provider determines the accessible tiered service types with the second service provider. After a user of the first service provider subscribes to a service at a certain level in the tiered services, the user is provided with the relevant service by using this scheme.

The user obtains the right to access the new service provided by the second service provider from the first service provider (similar to the process of obtaining the anonymous identity and private key and binding the Access_Attribute in the present disclosure). After obtaining the access right, the user initiates a request for accessing the new service provided by the second service provider. The second service provider verifies the access attribute claimed by the user (similar to the process of checking whether the client has the access attributes indicated by the Access_Attribute in the present disclosure) and redirects the client to the new service when the verification is passed. In addition, the second service provider returns a verification response. The process of determining the session key for accessing the new service may be included. After the user confirms the session key, a security channel for anonymous access using the anonymous identity based on the session key is established.

The service requestor identity management device provided in the present disclosure is not confined to the KGC, the service requestor device is not confined to the client, the service provider device is not confined to the enabler, and the identity tracing request device is not confined to the enabler.

In addition, those skilled in the art may complete all or part of the steps in the preceding method by using a program to instruct the hardware. The program may be stored in a storage medium that may be read by a computer. The procedure for executing the program may include the flows of the methods provided in an embodiment of the present disclosure. The storage medium may be disk tape, compact disk, Read-Only Memory (ROM), or Random Access Memory (RAM).

The preceding are specific implementation methods of the present disclosure. Those skilled in the art may make various modifications and variations to the disclosure without departing from the spirit and scope of the disclosure. The disclosure is intended to cover the modifications and variations provided that they fall in the scope of protection defined by the following claims or their equivalents.

1. A method for generating an identity of the service requestor, comprising:
obtaining an anonymous identity generating request to hide a real identity of a service requestor; and
generating part or whole of an anonymous identity related to the real identity according to the anonymous identity generating request.

2. The method of claim 1, wherein the anonymous identity generating request comprises an access attribute information of the service requestor, and the method further comprises:
verifying whether the service requestor has an access attribute indicated by the access attribute information, if the service requestor has the access attribute, then generating the part or all of an anonymous identity related to the real identity.

3. The method of claim 2, wherein the access attribute information comprises service provider information, and the verifying whether the service requestor has an access attribute indicated by the access attribute information specifically comprises:
judging whether the service requestor is associated with a service provider according to service provider information, and wherein if the service requestor is associated with a service provider, the verification is passed.

4. The method of claim 2, wherein the generating part or all of an anonymous identity related to the real identity further comprises:
adding the access attribute to the part or whole of an anonymous identity.

5. The method of claim 1, further comprising:
obtaining another part of the anonymous identity provided by the service requestor;
combining the another part of the anonymous identity and the part of the anonymous identity to obtain the anonymous identity;
verifying whether the another part of the anonymous identity provided by the service requestor meets requirements of the anonymous identity, if the the another part of the anonymous identity provided by the service requestor meets requirements of the anonymous identity, signing the another part of the anonymous identity.

6. The method of claim 1, wherein,
the anonymous identity generating request comprises the real identity and the first random factor, the generating part or whole of an anonymous identity related to the real identity further comprises:
generating all of the anonymous identity by using a Hash algorithm with the real identity and RAND_{—}1 as generating factors; and determining, corresponding relationship between the real identity and the anonymous identity; or
the generating part or whole of an anonymous identity related to the real identity further comprises:
using an identity that is not generated by the real identity as part or all part of the anonymous identity; and determining, corresponding relationship between the real identity and the anonymous identity.

7. The method of claim 1, further comprising,
using the anonymous identity as public key of the service requestor, after generating part or all of an anonymous identity related to the real identity:
generating part or whole of the private key that is related to the anonymous identity and that is adapted to represent legal anonymous identity of the service requestor.

8. The method of claim 7, wherein,
the generating part or whole of the private key that is related to the anonymous identity and that is adapted to represent legal anonymous identity of the service requestor comprises:
generating part or whole of the anonymous identity by using a Hash value and a main key as generating factors, wherein the Hash value is achieved by using the Hash algorithm with the part or whole of the anonymous identity.

9. A device for managing an identity of a service requestor, comprising,
a generating request obtaining unit, adapted to obtain an anonymous identity generating request from the anonymous service requestor; and
an anonymity generating unit, adapted to generate part or whole of an anonymous identity that is related to a real identity according to the anonymous identity generating request.

10. The device of claim 9, wherein the anonymous identity generating request comprises access
attribute information of the service requestor, the device further comprises:
a verifying unit, adapted to: verify whether the service requestor has an access attribute indicated by the access attribute information; if the service requestor has the access attribute, trigger the anonymous generating unit.

11. The device of claim 10, wherein the access attribute information comprises service provider information, the verifying unit further comprises:
a judging unit, adapted to judge whether the service requestor is associated with a service provider according to the real identity and the service provider information; and
a judging processing unit, adapted to trigger the anonymous generating unit when the service requestor is associated with a service provider.

12. The device of claim 10, wherein the part or whole of the anonymous identity comprises the access attribute information.

13. The device of claim 9, wherein the anonymous identity generating request comprises another part of the anonymous identity provided by the service requestor, the another part of the anonymous identity is combined with the part of the anonymous identity to obtain the anonymous identity, and the device further comprises:
a part signing unit, adapted to sign the another part of the anonymous identity when the verification of the another part of the anonymous identity provided by the service requestor that meets requirements of the anonymous identity is passed.

14. The device of claim 9, wherein,
the anonymous identity generating request comprises the real identity and the first random factor;
wherein the part or whole of the anonymous identity is formed by using a Hash algorithm with the real identity and RAND_{—}1 as generating factors; or the real identity as part or all part of the anonymous identity is an identity that is not generated by the real identity as part or all part of the anonymous identity.

15. The device of claim 9, wherein a public key of the service requestor is the anonymous identity, and the device further comprises:
a private key generating unit, adapted to generate the part or whole of the private key that is related to the anonymous identity and that is adapted to prove legal anonymous identity of the service requestor.

16. The device of claim 15, wherein the part or whole of the private key is achieved by using overall result of a Hash value and a main key, wherein the Hash value is achieved by using a Hash algorithm with the part or whole of the anonymous identity.

17. An identity generating system, comprising a device for managing an identity of a service requestor and a device for managing the service requestor, wherein the device for managing the service requestor comprises:
a request sending unit, adapted to send an anonymous identity generating request, wherein the anonymous identity generating request is adapted to hide an real identity of an service requestor and is related to the real identity; and
a response receiving unit, adapted to receive a response to the anonymous identity generating request;
and the device for managing an identity of a service requestor comprises:
a generating request obtaining unit, adapted to obtain an anonymous identity generating request from the anonymous service requestor; and
an anonymity generating unit, adapted to generate part or whole of an anonymous identity that is related to a real identity according to the anonymous identity generating request.

18. A service requestor identity management device, comprising:
a storage unit, adapted to store corresponding relationship between a real identity of the service requestor accessing a service anonymously and an anonymous identity adapted to hide the real identity of the service requestor;
a tracing request obtaining unit, adapted to obtain the request for tracing the real identity of the service requestor; and
an inquiry unit, adapted to query the corresponding relationship according to the request for tracing the real identity of the service requestor and obtain the real identity.
